(19) United States
(12) Patent Application Publication
(10) Pub. No.: US 2013/0315617 A1
(43) Pub. Date: Nov. 28, 2013

(54) IMAGE FORMING APPARATUS

(71) Applicants: Kenji Sugiura, Kanagawa (JP); Takaya Muraishi, Kanagawa (JP); Hisashi Kikuchi, Kanagawa (JP); Akira Asaoka, Kanagawa (JP); Yoshiki Hozumi, Kanagawa (JP); Yuu Sakakibara, Kanagawa (JP)

(72) Inventors: Kenji Sugiura, Kanagawa (JP); Takaya Muraishi, Kanagawa (JP); Hisashi Kikuchi, Kanagawa (JP); Akira Asaoka, Kanagawa (JP); Yoshiki Hozumi, Kanagawa (JP); Yuu Sakakibara, Kanagawa (JP)

(21) Appl. No.: 13/898,728

(22) Filed: May 21, 2013

(30) Foreign Application Priority Data
May 24, 2012 (JP) 2012-118953

(51) Int. Cl. G03G 15/16

(52) U.S. Cl. CPC G03G 15/161
USPC 399/101

(57) ABSTRACT

An image forming apparatus including a belt cleaning device is provided. The belt cleaning device includes an image bearing belt having an elastic layer, a cleaning member, a cleaning facing member, and a side seal. A surface of the image bearing belt is movable. The cleaning member is in contact with the surface of the image bearing belt to remove a substance adhered thereto. The cleaning facing member is disposed on a back-surface side of the image bearing belt while facing the cleaning member with the image bearing belt therebetween. The side seal is disposed to an axial end part of the cleaning member and pressed against the surface of the image bearing belt. The cleaning facing member is out of contact with the back side of the image bearing belt within an area where the cleaning facing member faces the side seal with respect to an axial direction.

### CROSS-REFERENCE TO RELATED APPLICATIONS

This patent application is based on and claims priority pursuant to 35 U.S.C. §119 to Japanese Patent Application No. 2012-118953, filed on May 24, 2012, in the Japan Patent Office, the entire disclosure of which is hereby incorporated by reference herein.

### BACKGROUND

1. Technical Field

The present disclosure relates to an image forming apparatus, such as a printer, a facsimile machine, and a copier.

2. Description of Related Art

JP-2011-133664-A discloses an intermediate transfer type full-color image forming apparatus including an intermediate transfer belt having an elastic layer; and a belt cleaning device. The belt cleaning device has a cleaning member disposed in contact with the intermediate transfer belt. The cleaning member is to be applied with a voltage to generate an electrostatic force for removing toner particles from the surface of the intermediate transfer belt.

The use of the intermediate transfer belt having an elastic layer suppresses the occurrence of defective transfer when a composite toner image, in which multiple color toner images are superimposed on one another, is secondarily transferred onto special papers such as those having a concavo-convex surface or those for use in thermal transfer. The elastic layer allows the intermediate transfer belt to deform so as to follow the surface asperity of toner layers or special papers. Thus, the intermediate transfer belt can intimately contact a toner layer without being applied with an excessive transfer pressure and can uniformly transfer the toner layer even onto a poor-smoothness recording medium without producing voids in the resulting text images.

In particular, the belt cleaning device has a brush roller as the cleaning member. The brush roller is disposed in contact with the intermediate transfer belt at a position downstream from the secondary transfer nip so as to face a cleaning facing roller that is one of multiple tension members for stretching the intermediate transfer belt taut. Thus, a cleaning nip is formed between a surface of the intermediate transfer belt and the brush roller. When a surface of the intermediate transfer belt passes through the cleaning nip, the brush roller is applied with a voltage so that the toner particles are electrostatically removed from the surface of the intermediate transfer belt.

### SUMMARY

In accordance with some embodiments, an image forming apparatus including a belt cleaning device is provided. The belt cleaning device includes an image bearing belt having an elastic layer, a cleaning member, a cleaning facing member, and a side seal. A surface of the image bearing belt is movable. The cleaning member is in contact with the surface of the image bearing belt to remove a substance adhered thereto. The cleaning facing member is disposed on a back-surface side of the image bearing belt while facing the cleaning member with the image bearing belt therebetween. The side seal is disposed to an axial end part of the cleaning member and pressed against the surface of the image bearing belt. The cleaning facing member is out of contact with the back side of the image bearing belt within an area where the cleaning facing member faces the side seal with respect to an axial direction.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic view of a belt cleaning device equipped with a side seal, viewed from the inner side of the belt cleaning device;

FIG. 2 is a schematic view illustrating an image forming apparatus according to an embodiment;

FIG. 3 is a magnified schematic view illustrating an optical sensor unit and an intermediate transfer belt equipped in the image forming apparatus illustrated in FIG. 2;

FIG. 4 is a schematic view illustrating a Chevron patch formed on the intermediate transfer belt 8;

FIG. 5 is a schematic view illustrating a toner consuming pattern transferred onto the intermediate transfer belt;

FIG. 6 is a magnified schematic view illustrating a belt cleaning device equipped in the image forming apparatus illustrated in FIG. 2 and its periphery;

FIG. 7 is a side view of the belt cleaning device equipped with a side seal;

FIG. 8 is an upper view of the belt cleaning device equipped with the side seal;

FIG. 9 is a schematic view of a side seal part of a belt cleaning device according to an embodiment, viewed from the inner side of the belt cleaning device;

FIG. 10 is a variation of the side seal part illustrated in FIG. 9, viewed from the inner side of the belt cleaning device;

FIG. 11 is another variation of the side seal part illustrated in FIG. 9, viewed from the inner side of the belt cleaning device;

FIG. 12 is a schematic view of a side seal part of a belt cleaning device according to another embodiment, viewed from the inner side of the belt cleaning device;

FIG. 13 is a schematic view of a side seal part of a belt cleaning device according to another embodiment, viewed from the inner side of the belt cleaning device;

FIG. 14 is a schematic view illustrating a toner particle for explaining the shape factor SF-1;

FIG. 15 is a schematic view illustrating a toner particle for explaining the shape factor SF-2;

FIGS. 16A, 16B, and 16C are schematic views illustrating a toner particle; and

FIG. 17 is a schematic view illustrating an image forming apparatus according to another embodiment.

### DETAILED DESCRIPTION

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

For the sake of simplicity, the same reference number will be given to identical constituent elements such as parts and materials having the same functions and redundant descriptions thereof omitted unless otherwise stated.

In a typical belt cleaning device, a brush roller is exposed from an opening of a casing to contact with an intermediate transfer belt. Both axial end parts of the opening are equipped with side seals and the side seals are pressed against the surface of the intermediate transfer belt so as to prevent toner particles from scattering from the end parts of the opening. However, if the belt cleaning device of the image forming apparatus described in JP-2011-133664-A, the intermediate transfer belt of which having an elastic layer, is equipped with side seals, surface migration of the intermediate transfer belt becomes unstable and banding or defective cleaning may occur. In addition, a portion of the intermediate transfer belt against which the side seal is pressed may gradually melt with time, resulting in poor durability of the intermediate transfer belt. A reason for this phenomenon is considered to be as follows.

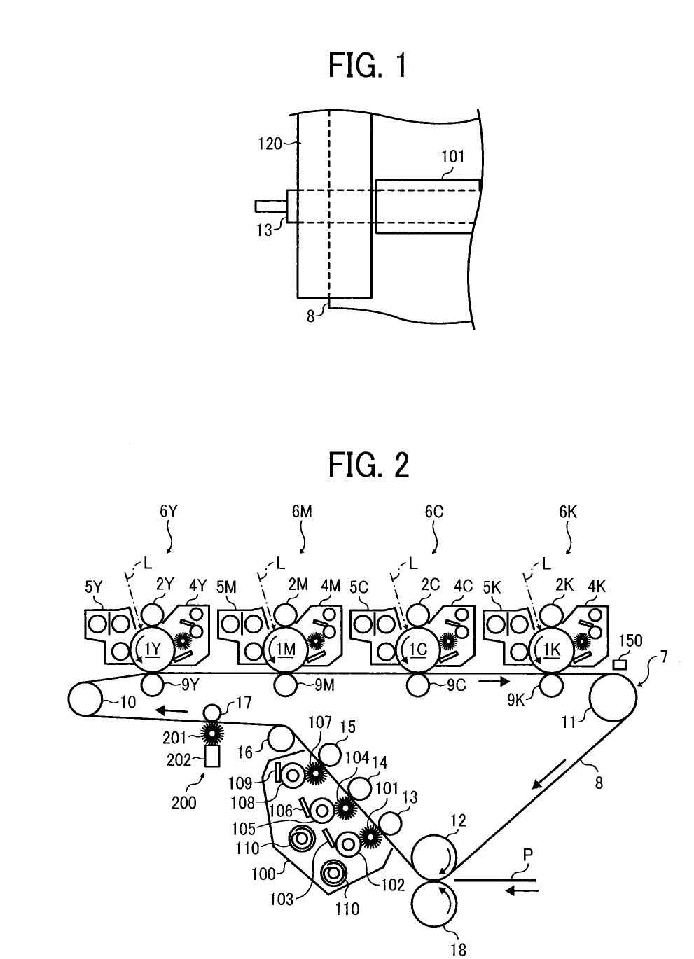

FIG. 1 is a schematic view of a belt cleaning device equipped with a side seal, viewed from the inner side of the belt cleaning device. As illustrated in FIG. 1, a side seal 120 is attached to an end part of a casing outside a brush roller 101 with respect to the axial direction. The side seal 120 is formed of, for example, an elastic body implanted with fibers. The side seal 120 is pressed against a surface of an intermediate transfer belt 8 with a predetermined amount of the side seal 120 being embedded in the intermediate transfer belt 8. The above configuration prevents toner particles from scattering. A cleaning facing roller 13 that is wider than the intermediate transfer belt 8 is disposed facing the back side of the intermediate transfer belt 8 (i.e., the opposite side to the brush roller 101). Within an area where the intermediate transfer belt 8 faces the belt cleaning device, the surface of the intermediate transfer belt 8 migrates while the side seal 120 is pressed against the axial end part of the intermediate transfer belt 8. At the cleaning nip where the intermediate transfer belt 8 is in contact with the brush roller 101, the surface of the intermediate transfer belt 8 migrates while the side seal 120 is pressed against the axial end part of the intermediate transfer belt 8 and the cleaning facing roller 13 is in contact with the back side of the intermediate transfer belt 8.

Compared to an intermediate transfer belt having no elastic layer, an intermediate transfer belt having an elastic layer is less slidable against the side seal because of its higher friction coefficient. Thus, the intermediate transfer belt having an elastic layer is subjected to a greater load during its surface migration. In particular, when passing through the cleaning nip, the surface of the intermediate transfer belt is subjected to a much greater load because the cleaning facing roller 13 is in contact with the back side of the intermediate transfer belt. As a result, surface migration of the intermediate transfer belt becomes unstable at the cleaning nip and therefore the resulting image is disturbed or the belt is undulated to cause defective cleaning.

Moreover, an intermediate transfer belt having an elastic layer is inferior to that having no elastic layer in terms of thermal durability. As the axial end parts of the intermediate transfer belt having an elastic layer are continuously subjected to a large load, the axial end parts get melted with increase in temperature with time. Experimental results by the inventors of the present invention have shown that the axial end parts of the intermediate transfer belt having an elastic layer start melting when the surface temperature of the belt gets 47° C.

The belt cleaning device described in JP-2011-133664-A has three brush rollers each serving as a cleaning member. Each of the brush rollers is to be applied with a voltage having a polarity opposite to or same as the normal polarity of toner so that toner particles having the opposite polarity to the voltage applied to the brush rollers are removed from the surface of the intermediate transfer belt. This belt cleaning device has three cleaning nips in each of which a large load is put to the axial end part of the intermediate transfer belt during surface migration of the intermediate transfer belt. Therefore, the above-described problem notably occurs in this belt cleaning device.

The above-described problem occurs not only in such intermediate transfer type full-color image forming apparatuses equipped with a belt cleaning device in which a brush roller is in contact with an intermediate transfer belt, serving as an image bearing belt, having an elastic layer to electrostatically clean the intermediate transfer belt. The problem may also occur in tandem direct transfer type full-color image forming apparatuses equipped with another type of belt cleaning device in which a brush roller is in contact with a transfer conveyance belt, serving as an image bearing belt, having an elastic layer to electrostatically clean the transfer conveyance belt. In either type of the belt cleaning devices, the cleaning member is not limited to a brush roller and a mechanism of removing toner particles is not limited to that using electrostatic force. Namely, the above-described problem may occur in all kinds of belt cleaning devices having a configuration in which a cleaning member is in contact with a surface of an image bearing belt having an elastic layer while facing a cleaning facing member that is one of multiple tension members stretching the image bearing belt taut. The problem may also occur in image forming apparatuses including a photoreceptor belt having an elastic layer as an image bearing belt.

In view of the above situations, one embodiment according to the present invention provides an image bearing member including a belt cleaning device having a cleaning member to clean a surface of an image bearing belt having an elastic layer while being in contact therewith. According to this embodiment, the occurrence of toner scattering is prevented because the side seal is pressed against the surface of the image bearing belt while the load on the image bearing belt is reduced. Thus, the image forming apparatus can provide excellent cleanability and high image quality for an extended period of time.

FIG. 2 is a schematic view illustrating an image forming apparatus according to an embodiment. This image forming apparatus is a tandem intermediate transfer type printer. The printer includes four processing units 6Y, 6M, 6C, and 6K to form toner images of yellow, magenta, cyan, and black, respectively. The processing units 6Y, 6M, 6C, and 6K include drum-shaped photoreceptors 1Y, 1M, 1C, and 1K, respectively. Chargers 2Y, 2M, 2C, and 2K, developing devices 5Y, 5M, 5C, and 5K, drum cleaning devices 4Y, 4M, 4C, and 4K, and neutralizers are respectively provided around the photoreceptors 1Y, 1M, 1C, and 1K. The processing units 6Y, 6M, 6C, and 6K have the same configuration except for containing different-color toners of yellow, magenta, cyan, and black, respectively. An optical writing unit to emit laser light beams L to write electrostatic latent images on the photoreceptors 1Y, 1M, 1C, and 1K is disposed above the processing units 6Y, 6M, 6C, and 6K.

A transfer unit 7 is disposed below the processing units 6Y, 6M, 6C, and 6K. The transfer unit 7 includes an intermediate transfer belt 8 that is seamless. The transfer unit 7 further includes multiple tension rollers provided inside the loop of the intermediate transfer belt 8; and a secondary transfer roller 18, a tension roller 16, a belt cleaning device 100, and a lubricant applicator 200, each provided outside the loop of the intermediate transfer belt 8.

Inside the loop of the intermediate transfer belt 8, four primary transfer rollers 9Y, 9M, 9C, and 9K, a driven roller 10, a driving roller 11, a secondary transfer facing roller 12, three cleaning facing rollers 13, 14, and 15, and an application brush facing roller 17 are disposed. Each of these rollers is partially in contact with the intermediate transfer belt 8 and functions as a tension roller for stretching the intermediate transfer belt 8 taut. The cleaning facing rollers 13, 14, and 15 do not necessarily have a function of stretching the intermediate transfer belt 8 and may be driven to rotate along with rotation of the intermediate transfer belt 8. The driving roller 11 is driven to rotate clockwise in FIG. 2 by a driver and the intermediate transfer belt 8 is further driven to endlessly move clockwise in FIG. 2 by the rotation of the driving roller 11.

A series of the primary transfer rollers 9Y, 9M, 9C, and 9K disposed inside the loop of the intermediate transfer belt 8 and a series of the photoreceptors 1Y, 1M, 1C, and 1K are sandwiching the intermediate transfer belt 8. Thus, primary transfer nips are formed in each of which the photoreceptor 1Y, 1M, 1C, or 1K is contacting an outer peripheral surface of the intermediate transfer belt 8. Each of the primary transfer rollers 9Y, 9M, 9C, and 9K is applied with a primary transfer bias having the opposite polarity to toner from a power source.

The secondary transfer facing roller 12 disposed inside the loop of the intermediate transfer belt 8 and the secondary transfer roller 18 disposed outside the loop of the intermediate transfer belt 8 is also sandwiching the intermediate transfer belt 8. Thus, a secondary transfer nip is formed in which the secondary transfer roller 18 is contacting a peripheral surface of the intermediate transfer belt 8. The secondary transfer roller 18 is applied with a secondary transfer bias having the opposite polarity to toner from a power source. The secondary transfer roller 18 and the secondary transfer facing roller 12 may be also sandwiching a paper conveying belt that is stretched across the secondary transfer roller 18 and several support and driving rollers together with intermediate transfer belt 8.

The three cleaning facing rollers 13, 14, and 15 disposed inside the loop of the intermediate transfer belt 8 and cleaning brush rollers 101, 104, and 107 of the belt cleaning device 100 disposed outside the loop of the intermediate transfer belt 8 are also sandwiching the intermediate transfer belt 8. Thus, cleaning nips are formed in each of which the cleaning brush roller 101, 104, or 107 is contacting a peripheral surface of the intermediate transfer belt 8. The belt cleaning device 100 and the intermediate transfer belt 8 are integrally replaceable. Alternatively, the belt cleaning device 100 and the intermediate transfer belt 8 may be independently replaceable when their setup lifespans are different. Details of the belt cleaning device 100 will be described later.

The printer further includes a paper feed part including a paper feed cassette to store sheets of a recording medium P and paper feed rollers to feed the sheets to paper feed paths. A pair of registration rollers is disposed on the right side of the secondary transfer nip in FIG. 2. The pair of registration rollers receives the recording medium P from the paper feed part and feeds it toward the secondary transfer nip in synchronization with an entry of a toner image to the secondary transfer nip. A fixing device is disposed on the left side of the secondary transfer nip in FIG. 2. The fixing device receives the recording medium P having the toner image thereon from the secondary transfer nip and fixes the toner image on the recording medium P. The printer may optionally include toner supply devices to supply respective toners of yellow, magenta, cyan, and black to the respective developing devices 5Y, 5M, 5C, and 5K, if necessary.

In addition to normal paper, for example, special papers having a concavo-convex surface or special recording papers for use in thermal transfer, such as iron print, may be used as the recording medium P. It is likely that toner images on the intermediate transfer belt 8 are more defectively transferred onto such special papers than onto normal paper. To solve the problem of defective transfer, the intermediate transfer belt 8 has a low-hardness elastic layer so that the intermediate transfer belt 8 can even deform following poor-smoothness recording media or toner layers. The low-hardness elastic layer gives elasticity to the intermediate transfer belt 8 and allows the surface of the intermediate transfer belt 8 to deform so as to follow the surface asperity of such poor-smoothness recording media or toner layers. Thus, the intermediate transfer belt can intimately contact a toner layer without being applied with an excessive transfer pressure and can uniformly transfer the toner layer even onto a poor-smoothness recording medium without producing voids in the resulting text images.

The intermediate transfer belt 8 includes at least a base layer, the elastic layer, and a surface coating layer.

Specific materials usable for the elastic layer of the intermediate transfer belt 8 include, but are not limited to, elastic rubbers and elastomers, such as butyl rubber, fluorine-based rubber, acrylic rubber, EPDM, NBR, acrylonitrile-butadiene-styrene rubber, natural rubber, isoprene rubber, styrene-butadiene rubber, butadiene rubber, urethane rubber, syndiotactic 1,2-polybutadiene, epichlorohydrin rubber, polysulfide rubber, polynorbornene rubber, and thermoplastic elastomers (e.g., polystyrene type, polyolefin type, polyvinyl chloride type, polyurethane type, polyamide type, polyurea type, polyester type, fluorine-based resin type). Two or more of these materials can be used in combination.

The thickness of the elastic layer is preferably from 0.07 to 0.8 mm, and more preferably from 0.25 to 0.5 mm, but it depends on the hardness and layer structure. When the thickness of the intermediate transfer belt 8 is less than 0.07 mm, toner particles on the intermediate transfer belt 8 is applied with an excessive pressure in the secondary transfer nip and it is likely that voids are produced in the resulting images with the decreasing toner transfer efficiency.

The JIS-A hardness (HS) of the elastic layer preferably satisfies an inequation 10°≦HS≦65°. Although an optimum hardness of the intermediate transfer belt 8 varies depending on its thickness, when the JIS-A hardness is less than 10°, it is likely that toner images are defectively transferred and voids are produced in the resulting images. When the JIS-A hardness exceeds 65°, it is difficult to stretch such an intermediate transfer belt across rollers. Also, such an intermediate transfer belt is not durable and needs to be replaced at an early stage because of being stretched for long periods.

The base layer of the intermediate transfer belt 8 is comprised of a poorly-extendable resin. Specific materials usable for the base layer include, but are not limited to, polycarbonate, fluorine-based resins (e.g., ETFE, PVDF), styrene-based resins (i.e., homopolymers and copolymers of styrene or styrene derivatives) such as polystyrene, chloropolystyrene, poly-α-methylstyrene, styrene-butadiene copolymer, styrene-vinyl chloride copolymer, styrene-vinyl acetate copolymer, styrene-maleic acid copolymer, styrene-acrylate copolymers (e.g., styrene-methyl acrylate copolymer, styrene-ethyl acrylate copolymer, styrene-butyl acrylate copolymer, styrene-octyl acrylate copolymer, styrene-phenyl acrylate copolymer), and styrene-methacrylate copolymers (e.g., styrene-methyl methacrylate copolymer, styrene-ethyl methacrylate copolymer, styrene-phenyl methacrylate copolymer), methyl methacrylate resin, butyl methacrylate resin, ethyl acrylate resin, butyl acrylate resin, modified acrylic resins (e.g., silicone-modified acrylic resin, vinyl-chloride-modified acrylic resin, acrylic-urethane resin), vinyl chloride resin, styrene-vinyl acetate copolymer, vinyl chloride-vinyl acetate copolymer, rosin-modified maleic acid resin, phenol resin, epoxy resin, polyester resin, polyester polyurethane resin, polyethylene, polypropylene, polybutadiene, polyvinylidene chloride, ionomer resin, polyurethane resin, silicone resin, ketone resin, ethylene-ethyl acrylate copolymer, xylene resin, polyvinyl butyral resin, polyamide resin, and modified polyphenylene oxide resin. Two or more of these materials can be used in combination.

To prevent the elastic layer comprised of an extendable material (e.g., rubber) from being extended, a core material layer may be provided between the base layer and the elastic layer. Specific usable materials for the core material layer include, but are not limited to, natural fibers (e.g., cotton, silk), synthetic fibers (e.g., polyester fiber, nylon fiber, acrylic fiber, polyolefin fiber, polyvinyl alcohol fiber, polyvinyl chloride fiber, polyvinylidene chloride fiber, polyurethane fiber, polyacetal fiber, polyfluoroethylene fiber, phenol fiber), inorganic fibers (e.g., carbon fiber, glass fiber), and metal fibers (e.g., iron fiber, copper fiber). Two or more of these materials can be used in combination. These materials are used after being formed into yarn or woven cloth. The yarn may be comprised of either a single filament or multiple filaments twisted together, such as single twist yarn, plied yarn, and two folded yarn. Two or more of the above-described materials may be formed into blended yarn. The yarn may be subjected to conductive treatments. The woven cloth may be either stockinette or combined weave, and may be also subjected to conductive treatments.

The surface coating layer of the intermediate transfer belt 8 is a smooth layer that covers the surface of the elastic layer. The surface coating layer preferably includes a material having poor adhesiveness to toner, which improves secondary transferability. For example, the surface coating layer may be comprised of one or more of polyurethane, polyester, or an epoxy resin, in which one or more of lubricating materials for reducing surface energy of the layer, such as fine particles of fluorine-containing resins, fluorine-containing compounds, carbon fluoride, titanium oxide, and silicon carbide, are dispersed. The particle diameters of the fine particles are variable. The surface coating layer may also be a fluorine-containing layer having a low surface energy which can be formed by thermally treating a fluorine-containing rubber.

Each of the base layer, elastic layer, and surface coating layer may include, for example, carbon black, graphite, metal powders (e.g., aluminum, nickel), and/or conductive metal oxides (e.g., tin oxide, titanium oxide, antimony oxide, indium oxide, potassium titanate, antimony-tin composite oxide (ATO), indium-tin composite oxide (ITO)), for the purpose of controlling resistance. The conductive metal oxides may be covered with insulative fine particles such as barium sulfate, magnesium silicate, or calcium carbonate, for example.

The surface of the intermediate transfer belt 8 is protected with a lubricant applied from the lubricant applicator 200. The lubricant applicator 200 includes a solid lubricant 202, such as a zinc stearate block, and an application brush roller 201 in contact with the solid lubricant 202. As the application brush roller 201 rotates, the application brush roller 201 scrapes off the solid lubricant 202 to obtain powdered lubricant and applies the powdered lubricant to the surface of the intermediate transfer belt 8. The lubricant applicator 200 is not always necessary. It depends on the quality and surface friction coefficient of materials used in the toner or intermediate transfer belt.

Upon reception of image information from a personal computer, the driving roller 11 is rotationally driven to endlessly move the intermediate transfer belt 8. The tension rollers other than the driving roller 11 are rotationally driven as the intermediate transfer belt 8 moves. Simultaneously, the photoreceptors 1Y, 1M, 1C, and 1K are rotationally driven in the respective processing units 6Y, 6M, 6C, and 6K. The surfaces of the photoreceptors 1Y, 1M, 1C, and 1K are uniformly charged by the respective chargers 2Y, 2M, 2C, and 2K and then exposed to laser light beams L so that electrostatic latent images are formed on each photoreceptors 1Y, 1M, 1C, and 1K. The developing devices 5Y, 5M, 5C, and 5K develop the electrostatic latent images on the respective surfaces of the photoreceptors 1Y, 1M, 1C, and 1K into respective toner images of yellow, magenta, cyan, and black. The toner images of yellow, magenta, cyan, and black are sequentially transferred onto an outer peripheral surface of the intermediate transfer belt 8 in the respective primary transfer nips. Thus, a composite toner image in which the toner images of yellow, magenta, cyan, and black are superimposed on one another is formed on the outer peripheral surface of the intermediate transfer belt 8.

At the same time, in the paper feed part, the paper feed roller feeds the recording medium P, sheet by sheet, from the paper feed cassette toward the pair of registration rollers. The pair of registration rollers is rotationally driven to feed a sheet of the recording medium P to the secondary transfer nip in synchronization with an entry of the composite toner image on the intermediate transfer belt 8 to the secondary transfer nip so that the composite toner image is transferred onto the recording medium P from the intermediate transfer belt 8. Thus, the composite full-color toner image is formed on the recording medium P. The recording medium P having the full-color toner image thereon is then fed from the secondary transfer nip to the fixing device. The full-color toner image is fixed on the recording medium P in the fixing device.

After the toner images of yellow, magenta, cyan, and black have been transferred from the photoreceptors 1Y, 1M, 1C, and 1K onto the intermediate transfer belt 8, the cleaning devices 4Y, 4M, 4C, and 4K remove residual toner particles remaining on the respective photoreceptors 1Y, 1M, 1C, and 1K without being transferred. The photoreceptors 1Y, 1M, 1C, and 1K are then neutralized with neutralization lamps and uniformly charged with the respective chargers 2Y, 2M, 2C, and 2K to be ready for the next image forming operation. After the composite toner image has been transferred from the intermediate transfer belt 8 onto the recording medium P, the belt cleaning device 100 removes residual toner particles remaining on the intermediate transfer belt 8 without being transferred.

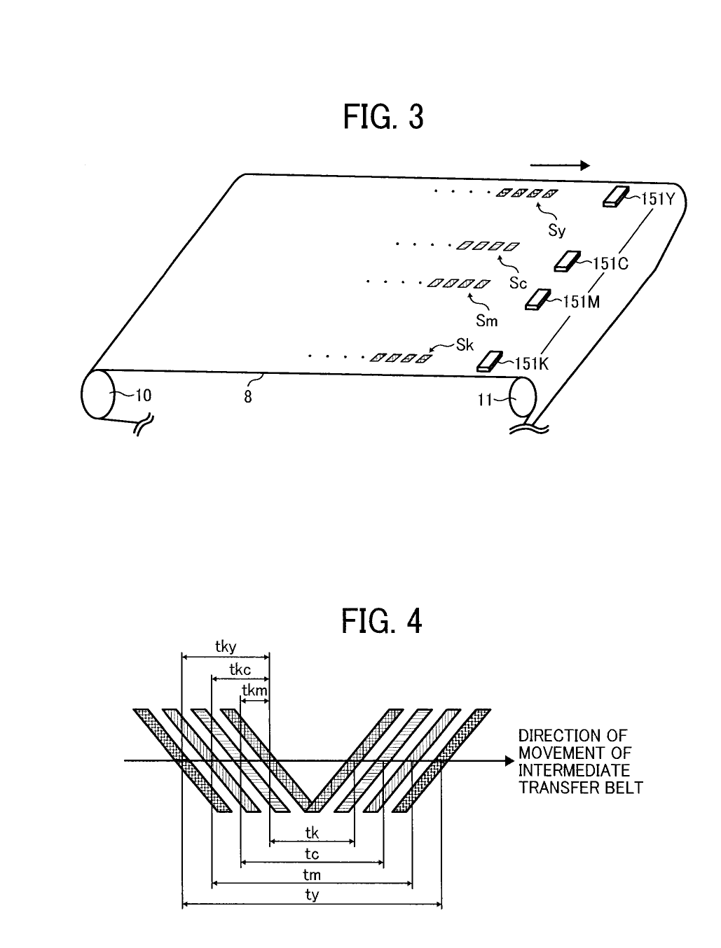

An optical sensor unit 150 is disposed on the right side of the processing unit 6K in FIG. 2 while facing an outer peripheral surface of the intermediate transfer belt 8 forming a predetermined gap therebetween. FIG. 3 is a magnified schematic view illustrating the optical sensor unit 150 and the intermediate transfer belt 8. The optical sensor unit 150 includes a yellow optical sensor 151Y, a cyan optical sensor 151C, a magenta optical sensor 151M, and a black optical sensor 151K arranged in the width direction of the intermediate transfer belt 8. Each of these sensors is a reflective photosensor in which a light-emitting element emits light to an outer peripheral surface of the intermediate transfer belt 8 or a toner image thereon and a light-receiving element detects the amount of the reflected light. A controller detects a toner image on the intermediate transfer belt 8 and its image density (i.e., the amount of toner per unit area) based on the output voltage from the above sensors.

Upon application of power or at every predetermined printing operation, the printer is subject to image density control to properly set image density of each color.

In the image density control, as shown in FIG. 3, gradation patterns Sk, Sm, Sc, and Sy of each color are automatically formed on the intermediate transfer belt 8 at the positions facing the optical sensors 151Y, 151M, 151C, and 151K, respectively. Each gradation pattern comprises ten toner patches each having a different image density and an area of 2 cm×2 cm. While the gradation patterns Sk, Sm, Sc, and Sy are formed, the surface potentials of the photoreceptors 1Y, 1M, 1C, and 1K are gradually increased, in contrast to the normal printing process in which the surface potentials are kept constant. On the other hand, multiple electrostatic latent patches are formed on each of the photoreceptors 1Y, 1M, 1C, and 1K by laser light scanning and then developed into toner patches by the developing devices 5Y, 5M, 5C, and 5K, respectively. While the electrostatic latent patches are developed into toner patches, the developing bias applied to the developing rollers are gradually increased. As a result, gradation patterns of yellow, magenta, cyan, and black are formed on the respective photoreceptors 1Y, 1M, 1C, and 1K. The gradation patterns are then primarily transferred onto the intermediate transfer belt 8 at a predetermined interval in the main scanning direction. Each toner patch includes the toner in an amount of 0.1 mg/cm² at minimum and 0.55 mg/cm² at maximum. Measurement of Q/d distribution demonstrates that toner particles substantially have normal polarity in each toner patch.

The gradation patterns Sk, Sm, Sc, and Sy pass the positions facing the respective optical sensors 151Y, 151M, 151C, and 151K as the intermediate transfer belt 8 endlessly moves. The optical sensors 151Y, 151M, 151C, and 151K receive an amount of light according to the amount of toner per unit area in each toner patch.

Next, the amount of toner in each toner patch is calculated from the output voltage from the optical sensor 151Y, 151M, 151C, or 151K upon detection of the toner patches and a conversion algorithm. Imaging conditions are adjusted based on the calculated amount of toner. More specifically, the amount of toner in each toner patch detected by the optical sensor and the developing potential upon developing each toner patch are compiled and subjected to a linear regression analysis to define a function (y=ax+b). The optimum developing bias is obtained by substituting a desired image density into the function.

A memory is storing an imaging condition data table correlating several tens of developing bias values with corresponding optimum charge potentials of the photoreceptors. Each of the processing units 6Y, 6M, 6C, and 6K selects a developing bias value closest to an actual developing bias from the imaging condition data table to determine the optimum charge potential of each photoreceptor.

Upon application of power or at every predetermined printing operation, the printer is subject to color deviation correction. In the color deviation correction, a color deviation detecting image, i.e., a Chevron patch as illustrated in FIG. 4, is formed on both ends of the intermediate transfer belt 8 in the width direction. The Chevron patch is comprised of linear toner images of yellow, magenta, cyan, and black each slanted about 45° relative to the main scanning direction and arranged at a predetermined interval in the direction of movement of the intermediate transfer belt 8 (i.e., the sub-scanning direction). The Chevron patch includes toner in an amount of 0.3 mg/cm².

Upon detection of the toner images in the Chevron patches on both ends of the intermediate transfer belt 8 in the width direction, the position in the main scanning direction (i.e., the axial direction of the photoreceptor), the position in the sub-scanning direction (i.e., the direction of movement of the intermediate transfer belt 8), the magnification error in the main scanning direction, and the skew from the main scanning direction are detected with respect to each of the toner images. The main scanning direction is coincident with a direction in which a laser light beam changes its phase on the photoreceptor upon reflection by a polygon mirror. The detection time differences tky, tkm, and tkc between detecting the black toner image and detecting the yellow, magenta, and cyan toner images, respectively, in the Chevron patch, are determined from the optical sensors 151. In FIG. 4, the main scanning direction is coincident with the vertical direction within the plane of paper. In the Chevron patch, a set of toner images of yellow, magenta, cyan, and black aligned in this order from the left and another set of toner images of black, cyan, magenta, and yellow aligned in this order from the left and slanted 90° from the former set of toner images are arranged side by side. The deviation amount in the sub-scanning direction, i.e., the amount of registration deviation, with respect to each of the toner images is determined based on the differences between the actual and ideal values of the detection time differences tky, tkm, and tkc. The timing for optically writing an image on the photoreceptor 1 is adjusted with respect to every face of the polygon mirror, i.e., per scanning line pitch, based on the amount of registration deviation, so that registration deviation is suppressed. The skew from the main scanning direction with respect to each of the toner images is determined based on the difference in deviation amount in the sub-scanning direction between both ends of the intermediate transfer belt 8. Optical face tangle error correction is conducted based on the measured skew so that skew deviation is suppressed. In summary, in the color deviation correction, the timings of optical writing and optical face tangle error are corrected based on the detection times of the toner images in the Chevron patch, so that registration and skew deviations are suppressed. Even when the positions on the intermediate transfer belt 8 at which toner images are formed are temporarily deviated due to temperature change, color deviation is suppressed by the above-described color deviation correction.

When a low-image-area image is continuously produced, spent toner particles are gradually increased and accumulate in the developing device. Such spent toner particles are poor in chargeability and degrade the resulting image quality, resulting in deterioration of developability and transferability. To solve this problem, the printer can execute a refresh mode in which spent toner particles are forcibly discharged from the developing devices to non-image areas on the photoreceptors 1Y, 1M, 1C, and 1K at regular intervals and fresh toner particles are supplied to the developing devices.

A control part stores data regarding toner consumption and operation time in the developing devices 5Y, 5M, 5C, and 5K. Thus, the control part checks at a predetermined timing whether toner consumption within a predetermined operation time period is subthreshold or not in each of the developing devices 5Y, 5M, 5C, and 5K, and then executes the refresh mode only in the developing devices in which the toner consumption is subthreshold.

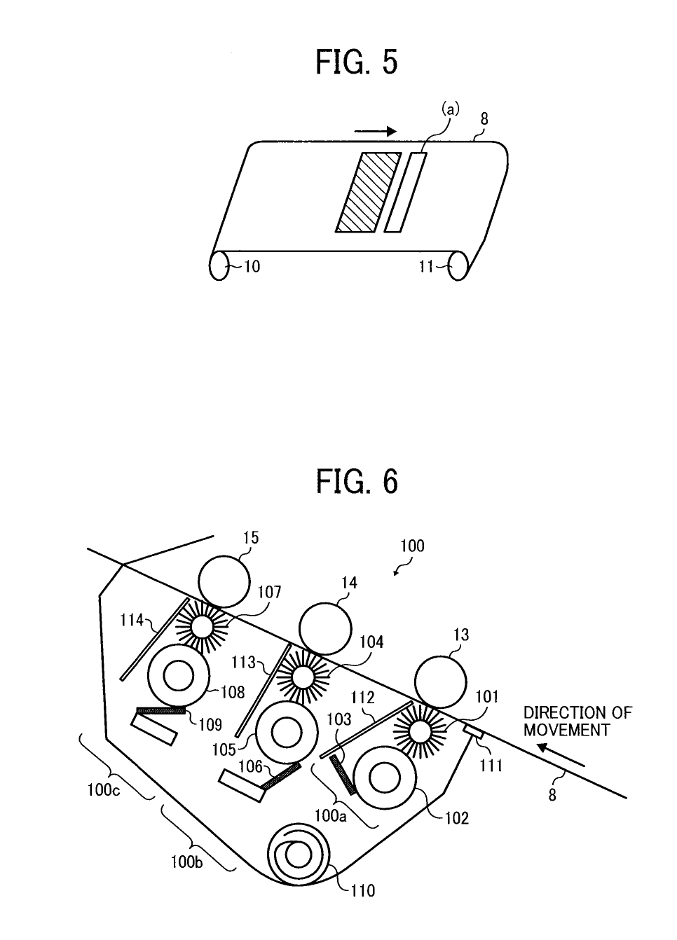

In the refresh mode, a toner consuming pattern (a) is formed on a non-image area, corresponding to the interval between paper sheets, on each photoreceptor and is transferred onto the intermediate transfer belt 8, as illustrated in FIG. 5. The amount of toner in the toner consuming pattern is determined based on the toner consumption per unit operation time of the developing device. The maximum amount of toner on the intermediate transfer belt may be about 1.2 mg/cm². Measurement of Q/d distribution of the toner consuming pattern (a) having been transferred onto the intermediate transfer belt 8 demonstrates that the toner particles substantially have normal polarity. In the present embodiment, the size of the toner consuming pattern is 25 mm×250 mm.

The gradation patterns, Chevron patches, and toner consuming patterns on the intermediate transfer belt 8 are collected by the belt cleaning device 100. The belt cleaning device 100 have to remove a large amount of toner particles from the intermediate transfer belt 8. A related-art cleaning device including a polarity controller and a brush roller, or that including a brush roller to remove positive toner particles and another brush roller to remove negative toner particles cannot remove the untransferred toner images, such as the gradation patterns, Chevron patches, and toner consuming patterns, all at once. If toner particles are remaining on the intermediate transfer belt 8 without being removed, the remaining toner particles may be transferred onto a recording medium during a next printing operation, which results in production of abnormal images.

The belt cleaning device 100 of the printer according to an embodiment is configured to remove untransferred toner images, such as the gradation patterns, Chevron patches, and toner consuming patterns, all at once from the intermediate transfer belt 8.

FIG. 6 is a magnified schematic view illustrating the belt cleaning device 100 and its periphery. The belt cleaning device 100 includes a pre-cleaning part 100a to roughly remove untransferred toner images from the intermediate transfer belt 8; an oppositely-charged toner cleaning part 100b to remove oppositely-charged (i.e., positively-charged) toner particles from the intermediate transfer belt 8; and a normally-charged toner cleaning part 100c to remove normally-charged (i.e., negatively-charged) toner particles from the intermediate transfer belt 8.

The pre-cleaning part 100a has a pre-cleaning brush roller 101 serving as a pre-cleaning member. Further, the pre-cleaning part 100a has a pre-collection roller 102, serving as a pre-collection member, to collect toner particles adhered to the pre-cleaning brush roller 101; and a pre-scraping blade 103, serving as a pre-scraping member, in contact with the pre-collection roller 102. The pre-scraping blade 103 scrapes off toner particles from the surface of the pre-collection roller 102.

Most toner particles in the untransferred toner images are normally (i.e., negatively) charged. Therefore, the pre-cleaning brush roller 101 is applied with a voltage having the opposite (i.e., positive) polarity to the normal (i.e., negative) polarity of the toner so that normally-charged (i.e., negatively-charged) toner particles are electrostatically removed from the intermediate transfer belt 8. The pre-collection roller 102 is applied with a positive-polarity voltage greater than that applied to the pre-cleaning brush roller 101. In the belt cleaning device 100, the voltage to be applied to the pre-cleaning brush roller 101 is properly set such that 90% of the untransferred toner images are removed by the pre-cleaning brush roller 101.

The pre-cleaning part 100a has a feed screw 110 to feed toner particles to a waste toner tank equipped in the main body of the image forming apparatus.

The oppositely-charged toner cleaning part 100b is disposed downstream from the pre-cleaning part 100a relative to the direction of movement of the intermediate transfer belt 8. The oppositely-charged toner cleaning part 100b has an oppositely-charged toner cleaning brush roller 104, serving as an oppositely-charged toner cleaning member, to electrostatically remove oppositely-charged (i.e., positively-charged) toner particles. Further, the oppositely-charged toner cleaning part 100b has an oppositely-charged toner collection roller 105, serving as an oppositely-charged toner collection member, to collect oppositely-charged toner particles adhered to the oppositely-charged toner cleaning brush roller 104; and an oppositely-charged toner scraping blade 106, serving as an oppositely-charged toner scraping member, in contact with the oppositely-charged toner collection roller 105. The oppositely-charged toner scraping blade 106 scrapes off toner particles from the surface of the oppositely-charged toner collection roller 105. The oppositely-charged toner cleaning brush roller 104 is applied with a negative-polarity voltage. The oppositely-charged toner collection roller 105 is applied with a negative-polarity voltage greater than that applied to the oppositely-charged toner cleaning brush roller 104. The oppositely-charged toner cleaning part 100b also serves as a polarity controller to control the polarity of toner particles on the intermediate transfer belt 8 to be normal (i.e., negative), by negatively charging the toner particles.

The normally-charged toner cleaning part 100c is disposed downstream from the oppositely-charged toner cleaning part 100b relative to the direction of movement of the intermediate transfer belt 8. The normally-charged toner cleaning part 100c has a normally-charged toner cleaning brush roller 107, serving as a normally-charged toner cleaning member, to electrostatically remove normally-charged (i.e., negatively-charged) toner particles. Further, the normally-charged toner cleaning part 100c has a normally-charged toner collection roller 108, serving as a normally-charged toner collection member, to collect normally-charged toner particles adhered to the normally-charged toner cleaning brush roller 107; and a normally-charged toner scraping blade 109, serving as a normally-charged toner scraping member, in contact with the normally-charged toner collection roller 108. The normally-charged toner scraping blade 109 scrapes off toner particles from the surface of the normally-charged toner collection roller 108. The normally-charged toner cleaning brush roller 107 is applied with a positive-polarity voltage. The normally-charged toner collection roller 108 is applied with a positive-polarity voltage greater than that applied to the normally-charged toner cleaning brush roller 107.

The pre-cleaning part 100a and the oppositely-charged toner cleaning part 100b are divided with a first insulative seal member 112 in contact with the pre-cleaning brush roller 101. By dividing the pre-cleaning part 100a and the oppositely-charged toner cleaning part 100b by the first insulative seal member 112, the occurrence of electrical discharge between the pre-cleaning brush roller 101 and the oppositely-charged toner cleaning brush roller 104 or the readhesion of toner particles removed in the oppositely-charged toner cleaning part 100b to the pre-cleaning brush roller 101 is suppressed.

The oppositely-charged toner cleaning part 100b and the normally-charged toner cleaning part 100c are divided with a second insulative seal member 113 in contact with the oppositely-charged toner cleaning brush roller 104. By dividing the oppositely-charged toner cleaning part 100b and the normally-charged toner cleaning part 100c by the second insulative seal member 113, the occurrence of electrical discharge between the oppositely-charged toner cleaning brush roller 104 and the normally-charged toner cleaning brush roller 107 or the readhesion of toner particles removed in the normally-charged toner cleaning part 100c to the oppositely-charged toner cleaning brush roller 104 is suppressed.

At the exit part of the belt cleaning device 100, a third insulative seal member 114 is disposed in contact with the normally-charged toner cleaning brush roller 107. The third insulative seal member 114 suppresses the occurrence of electrical discharge between the normally-charged toner cleaning brush roller 107 and the tension roller 16.

The belt cleaning device 100 further includes an entrance seal 111 and a waste toner case. The waste toner case stores toner particles removed in the oppositely-charged toner cleaning part 100b and the normally-charged toner cleaning part 100c. The waste toner case is detachably attached to the belt cleaning device 100. The waste toner case is detachable from the belt cleaning device 100 while waste toner particles accumulated in the waste toner case are removed therefrom.

Toner particles removed in the oppositely-charged toner cleaning part 100b and the normally-charged toner cleaning part 100c are stored in the waste toner case, as described above, but the belt cleaning device 100 does not necessarily include the waste toner case. For example, toner particles removed in the oppositely-charged toner cleaning part 100b and the normally-charged toner cleaning part 100c may be fed to another waste toner tank equipped in the image forming apparatus while providing a feed member at the bottom of the belt cleaning device 100 to feed toner particles to the feed screw 110 or making the bottom of the belt cleaning device 100 be slanted toward the feed screw 110. Alternatively, a second feed screw may be further provided to feed toner particles removed in the oppositely-charged toner cleaning part 100b and the normally-charged toner cleaning part 100c to the waste toner tank equipped in the image forming apparatus.

Each of the cleaning brush rollers 101, 104, and 107 is comprised of a metallic rotary shaft member that is rotatably supported; and a brush part comprised of multiple bristles raised on the peripheral surface of the metallic rotary shaft member. Each of the cleaning brush rollers 101, 104, and 107 has an outer diameter of from 15 to 16 mm. Each of the raised bristles has a two-layer core-in-sheath structure. The core part may be comprised of a conductive material, such as conductive carbon, and the sheath (surface) part may be comprised of an insulative material, such as polyester. Thus, the core part is charged to have a potential substantially equal to the voltage applied to the cleaning brush roller and is able to electrostatically attract toner particles to the bristles raised on its surface. As a result, toner particles on the intermediate transfer belt 8 are electrostatically attracted to the raised bristles by action of the voltage applied to the cleaning brush roller. Alternatively, each of the bristles raised on the cleaning brush rollers 101, 104, and 107 may be comprised of a conductive fiber without taking a two-layer core-in-sheath structure. The bristles may be implanted while being slanted along the normal direction of the rotary shaft member. According to an embodiment, the raised bristles on the pre-cleaning brush roller 101 and normally-charged toner cleaning brush roller 107 take core-in-sheath structures while those on the oppositely-charged toner cleaning brush roller 104 are comprised of conductive fibers. The raised bristles on the oppositely-charged toner cleaning brush roller 104 comprised of conductive fibers makes it easier to cause charge injection from the oppositely-charged toner cleaning brush roller 104 to toner particles. Accordingly, the oppositely-charged toner cleaning brush roller 104 reliably controls toner particles on the intermediate transfer belt 8 to have a uniform negative polarity. The raised bristles on the pre-cleaning brush roller 101 and normally-charged toner cleaning brush roller 107 having core-in-sheath structure suppress the occurrence of charge injection to toner particles. Thus, toner particles on the intermediate transfer belt 8 are suppressed from positively charged. The pre-cleaning brush roller 101 and normally-charged toner cleaning brush roller 107 suppress generation of toner particles which cannot be electrostatically removed.

Each of the cleaning brush rollers 101, 104, and 107 is embedded in the intermediate transfer belt 8 for a depth of 1 mm and is driven to rotate by a driver such that the raised bristles face in the direction of movement of the intermediate transfer belt 8 at each contact position. Rotating each of the cleaning brush rollers 101, 104, and 107 such that the raised bristles face in the direction of movement of the intermediate transfer belt 8 at each contact position makes the difference in linear speed between each cleaning brush roller and the intermediate transfer belt 8 much larger. Thus, the probability that a portion on the intermediate transfer belt 8 contacts the raised bristles within the contact area gets much larger and toner particles are removed from the intermediate transfer belt 8 efficiently.

In the belt cleaning device 100, each of the collection rollers 102, 105, and 108 is comprised of an SUS roller. The collection rollers 102, 105, and 108 are not limited in materials so long as toner particles adhered to the cleaning brush rollers are transferred onto the collection rollers by action of the potential gradient formed between the raised bristles and the collection rollers. For example, each of the collection rollers 102, 105, and 108 may be comprised of a conductive cored bar covered with a high-resistance elastic tube having a thickness of several to 100 μm or that having an insulative coating, to have a resistivity R (Ω·cm) satisfying the equation 12≦log R≦14. The collection rollers 102, 105, and 108 comprised of SUS rollers are advantageous in saving cost and energy (e.g., application voltage). When the equation 12≦log R≦14 is satisfied, the occurrence of charge injection to toner particles is suppressed when the collection rollers collect the toner particles, and therefore the toner particles have the same polarity to the voltage applied to the collection rollers. Thus, deterioration of toner collection rate is prevented.

Conditions of the cleaning brush rollers 101, 104, and 107 are as follows.

Brush material: a conductive polyester having a core-sheath structure (the core being a conductive carbon and the sheath being a polyester)

Brush resistance: from 10⁻⁶ to 10⁻⁸Ω

Brush implantation density: from 60,000 to 150,000 bristles/inch²

Brush bristle diameter: about 25 to 35 μm

Brush edge slanting treatment: N/A

Brush diameter: 14 to 20 mm

Amount of brush bristle embedded in the intermediate transfer belt 8: from 1 to 1.5 mm

The voltage applied to the pre-cleaning brush roller 101 is set such that even an untransferred toner image containing a large amount of toner is reliably removed from the intermediate transfer belt 8. The voltage applied to the oppositely-charged toner cleaning brush roller 104 is set relatively high in absolute value so that charge are injected to toner particles on the intermediate transfer belt 8. The brush implantation density, brush resistance, brush bristle diameter, application voltage, brush material, and embedded amount of brush bristles are optimized according to the system in use. The brush bristle may be formed of, for example, nylon, acrylic, or polyester.

Conditions of the collection rollers 102, 105, and 108 are as follows.

Cored metal material: SUS303

Amount of brush bristle embedded in the collection rollers: from 1 to 1.5 mm

The roller material, embedded amount of brush bristles, and application voltage are optimized according to the system in use.

Conditions of the scraping blades 103, 106, and 109 are as follows.

Material: SUS304

Blade contacting angle: 20°

Blade thickness: 0.1 mm

Amount of blade embedded in the collection rollers: from 0.5 to 1.5 mm

The blade contacting angle, blade thickness, and embedded amount of blade are optimized according to the system in use.

A cleaning operation in the belt cleaning device 100 is described in detail below.

As illustrated in FIG. 6, residual toner particles and untransferred toner images remaining on the intermediate transfer belt 8, having passed through the secondary transfer part, are fed to a position facing the pre-cleaning brush roller 101 via the contact position with the entrance seal 111 as the intermediate transfer belt 8 rotates. The pre-cleaning brush roller 101 is applied with a voltage having the opposite (i.e., positive) polarity to the normal polarity of the toner. An electric field formed between the intermediate transfer belt 8 and the pre-cleaning brush roller 101 due to the surface potential difference therebetween transfers negatively-charged toner particles on the intermediate transfer belt 8 onto the pre-cleaning brush roller 101 by electrostatic adsorption. The negatively-charged toner particles transferred onto the pre-cleaning brush roller 101 are then fed to the contact position with the pre-collection roller 102 being applied with a positive-polarity voltage greater than that applied to the pre-cleaning brush roller 101. An electric field formed between the pre-cleaning brush roller 101 and the pre-collection roller 102 due to the surface potential difference therebetween further transfers the negatively-charged toner particles having been transferred onto the pre-cleaning brush roller 101 onto the pre-collection roller 102 by electrostatic adsorption. The toner particles are then scraped off from the pre-collection roller 102 by the pre-scraping blade 103. The toner particles scraped off by the pre-scraping blade 103 are then discharged from the apparatus by the feed screw 110.

Toner particles which have not been removed by the pre-cleaning brush roller 101, such as negatively-charged or positively-charged toner particles in the untransferred toner images and positively-charged residual toner particles remaining on the intermediate transfer belt 8, are fed to a position facing the oppositely-charged toner cleaning brush roller 104. The oppositely-charged toner cleaning brush roller 104 is applied with a voltage having the same (i.e., negative) polarity to the normal polarity of the toner and controls toner particles on the intermediate transfer belt 8 to have a uniform negative polarity by means of charge injection and electric discharge. At the same time, an electric field formed between the intermediate transfer belt 8 and the oppositely-charged toner cleaning brush roller 104 due to the surface potential difference therebetween transfers positively-charged toner particles on the intermediate transfer belt 8 onto the oppositely-charged toner cleaning brush roller 104 by electrostatic adsorption. The positively-charged toner particles transferred onto the oppositely-charged toner cleaning brush roller 104 are then fed to the contact position with the oppositely-charged toner collection roller 105 being applied with a negative-polarity voltage greater than that applied to the oppositely-charged toner cleaning brush roller 104. An electric field formed between the oppositely-charged toner cleaning brush roller 104 and the oppositely-charged toner collection roller 105 due to the surface potential difference therebetween further transfers the positively-charged toner particles having been transferred onto the oppositely-charged toner cleaning brush roller 104 onto the oppositely-charged toner collection roller 105 by electrostatic adsorption. The toner particles are then scraped off from the oppositely-charged toner collection roller 105 by the oppositely-charged toner scraping blade 106.

Toner particles the polarities of which have been shifted to negative by the oppositely-charged toner cleaning brush roller 104 and those which have not been removed by the pre-cleaning brush roller 101 are fed to the normally-charged toner cleaning brush roller 107. Toner particles to be fed to the normally-charged toner cleaning brush roller 107 are controlled to have a negative polarity by the oppositely-charged toner cleaning brush roller 104. Most toner particles on the intermediate transfer belt 8 have been removed by the pre-cleaning brush roller 101 and the oppositely-charged toner cleaning brush roller 104. Therefore, the amount of toner particles to be fed to the normally-charged toner cleaning brush roller 107 is very small. Such negatively-charged toner particles in a small amount having been fed from the intermediate transfer belt 8 to the normally-charged toner cleaning brush roller 107 are electrostatically adhered to the normally-charged toner cleaning brush roller 107 applied with a voltage having the opposite (i.e., positive) polarity to the normal polarity of the toner. The toner particles are then collected by the normally-charged toner collection roller 108 and scraped off from the normally-charged toner collection roller 108 by the normally-charged toner scraping blade 109.

In the belt cleaning device 100, the pre-cleaning brush roller 101 roughly removes negatively-charged toner particles that occupy a great part of the untransferred toner images. Thus, the amount of toner particles to be input to the oppositely-charged toner cleaning brush roller 104 or normally-charged toner cleaning brush roller 107 is reduced. Toner particles which are to be fed to the normally-charged toner cleaning brush roller 107, disposed most downstream relative to the direction of movement of the intermediate transfer belt, are those which have not been removed by the pre-cleaning brush roller 101 or the oppositely-charged toner cleaning brush roller 104. Therefore, the amount of such toner particles is very small. Additionally, such toner particles have been controlled to have a uniform negative polarity. Such toner particles are satisfactorily removed by the normally-charged toner cleaning brush roller 107. Thus, even an untransferred toner image containing a large amount of toner can be reliably removed from the intermediate transfer belt 8.

Residual toner particles remaining on the intermediate transfer belt, the amount of which is smaller than that of the untransferred toner image, are reliably removed by the three cleaning brush rollers 101, 104, and 107.

In the belt cleaning device 100, positively-charged toner particles on the intermediate transfer belt 8 are removed by the oppositely-charged toner cleaning brush roller 104. Alternatively, according to another embodiment, the oppositely-charged toner cleaning part 100b is replaced with a polarity control part in which positively-charged toner particles on the intermediate transfer belt 8 are not removed. In the polarity control part, toner particles on the intermediate transfer belt 8 having passed through the pre-cleaning brush roller 101 are controlled to have a negative polarity. The toner particles are then fed to the normally-charged toner cleaning brush roller 107 disposed downstream from the polarity control part relative to the direction of movement of the intermediate transfer belt 8. The toner particles having been controlled to have a negative polarity are then removed by the normally-charged toner cleaning brush roller 107. Means for injecting negative charge to toner particles on the intermediate transfer belt 8 in the polarity control part include, for example, a conductive brush, a conductive blade, or a corona charger. Alternatively, according to another embodiment, toner particles on the intermediate transfer belt 8 are controlled to have a positive polarity, not a negative polarity, and then removed by a cleaning brush roller applied with a negative-polarity voltage disposed downstream from the polarity control part relative to the direction of movement of the intermediate transfer belt 8. The amount of toner particles to be fed to the polarity control part is very small because most toner particles in the untransferred toner images on the intermediate transfer belt 8 have been roughly removed by the pre-cleaning brush roller 101. Accordingly, in the polarity control part, toner particles on the intermediate transfer belt 8 can be controlled to have a uniform arbitrary polarity. As a result, toner particles on the intermediate transfer belt 8 are electrostatically removed by a cleaning brush roller disposed downstream from the polarity control part. Thus, even when an untransferred toner image containing a large amount of toner particles is input into the belt cleaning device 100, toner particles are reliably removed from the intermediate transfer belt 8.

In the present embodiment, all of the collection rollers 102, 105, and 108 and cleaning brush rollers 101, 104, and 107 are applied with a voltage. According to another embodiment, only the collection rollers 102, 105, and 108 are applied with a voltage. In such an embodiment, the cleaning brush roller is applied with a bias voltage lower than that applied to the collection roller because the potential of the cleaning brush roller falls due to the resistance of bristles while the cleaning brush roller is contacting the collection roller. Thus, a potential difference is formed between the collection roller and the cleaning brush roller and toner particles are electrostatically transferred from the cleaning brush rollers to the collection rollers due to the potential gradient.

In the present embodiment, each of the cleaning brush rollers 101, 104, and 107 and collection rollers 102, 105, and 108 is applied with a predetermined voltage as follows. The process linear speed of the belt cleaning device 100 is 600 mm/s.

Pre-cleaning brush roller 101: +2,400 V

Pre-collection roller 102: +2,800 V

Oppositely-charged toner cleaning brush roller 104: −2,600 V

Oppositely-charged toner collection roller 105: −3,000 V

Normally-charged toner cleaning brush roller 107: +1,000 V

Normally-charged toner collection roller 108: +1,400 V

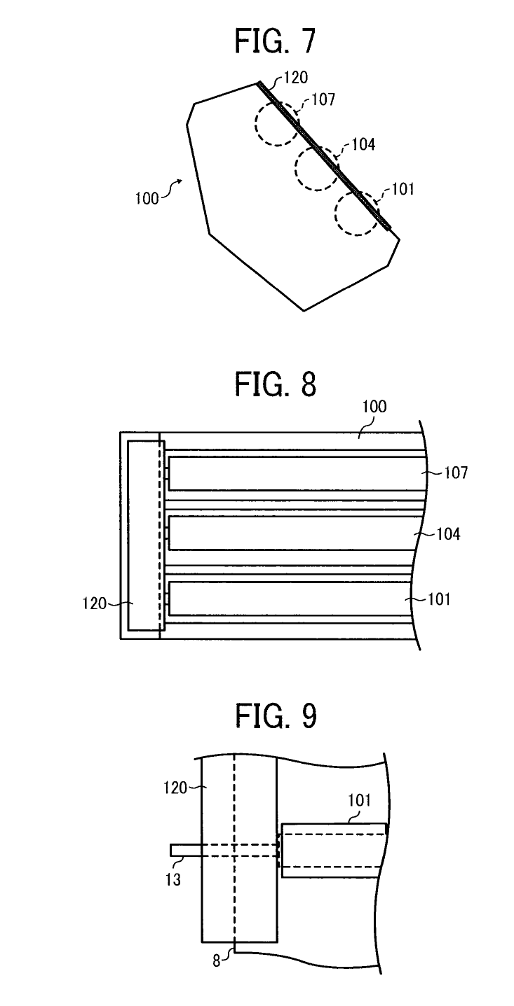

In the belt cleaning device 100, the cleaning brush rollers 101, 104, and 107 are exposed from an opening of a casing to contact with the intermediate transfer belt 8. The opening is equipped with a side seal 120 and the side seal 120 is pressed against the surface of the intermediate transfer belt 8 so as to prevent toner particles from scattering from the ends of the opening. FIG. 7 is a side view of the belt cleaning device 100 equipped with the side seal 120. FIG. 8 is an upper view of the belt cleaning device 100 equipped with the side seal 120. The side seal 120 is attached with an amount of double-faced adhesive tape to an edge surface of an axial end part of the casing outside the cleaning brush rollers 101, 104, and 107 in the axial direction. Upon installation of the belt cleaning device 100 to the transfer unit 7, the side seal 120 is pressed against the intermediate transfer belt 8 with a predetermined amount of the side seal 120 being embedded in the intermediate transfer belt 8 at between the casing of the belt cleaning device 100 and the intermediate transfer belt 8. In the embodiment illustrated in FIGS. 7 and 8, a single strip of the side seal 120 is covering over the entrance and exit parts of the opening of the casing of the belt cleaning device 100. Alternatively, according to another embodiment, multiple strips of the side seal 120 may be provided thereto.

In the belt cleaning device 100, the cleaning facing rollers 13, 14, and 15 are disposed facing the back surface of the intermediate transfer belt 8. The cleaning facing rollers 13, 14, and 15 are out of contact with the back surface of the intermediate transfer belt 8 within an area facing the side seal 120 with respect to the axial direction. Thus, a surface of the intermediate transfer belt 8 passes through the contact positions with the cleaning brush rollers 101, 104, and 107 while reducing the load on the intermediate transfer belt 8. The side seal 120 is described in detail with reference to Examples 1 to 3. Because the cleaning brush rollers 101, 104, and 107 have the same configuration with respect to the side seal part, only the cleaning brush roller 101 and its periphery are described in Examples 1 to 3.

### Example 1

FIG. 9 is a schematic view of a side seal part of a belt cleaning device according to an embodiment (hereinafter “Example 1”), viewed from the inner side of the belt cleaning device. A side seal part illustrated in FIG. 9 is on a front side of the belt cleaning device in the axial direction. As illustrated in FIG. 9, the side seal 120 is attached to an axial end part of a casing outside the brush roller 101 with respect to the axial direction, with a predetermined amount of the side seal 120 being embedded in the intermediate transfer belt 8. Within an area where a surface of the intermediate transfer belt 8 is in contact with the brush roller 101, the back side of the intermediate transfer belt 8 is in contact with the cleaning facing roller 13 that is wider than the intermediate transfer belt 8. The axial end part of the cleaning facing roller 13 is disposed inside an area where the intermediate transfer belt 8 is in contact with the side seal 120 and outside the end part of the brush roller 101 with respect to the axial direction.

Within an area where the intermediate transfer belt 8 is in contact with the brush roller 101, the back surface of the intermediate transfer belt 8 is in contact with the cleaning facing roller 13 to form a cleaning nip in which the above-described electrostatic cleaning operation is performed. By contrast, within an area where the intermediate transfer belt 8 is in contact with the side seal 120, the back surface of the intermediate transfer belt 8 is out of contact with the cleaning facing roller 13. Therefore, a surface of the intermediate transfer belt 8 passes through the contact position with the brush roller 101 with the axial end part thereof, against which the side seal 120 is pressed, being free without contacting the cleaning facing roller 13. Thus, a surface of the intermediate transfer belt 8, even having an elastic layer, can pass through the contact position with the brush roller 101 with being subjected to a reduced load. The belt cleaning device 100 is equipped with the intermediate transfer belt 8 having an elastic layer and the side seal 120. The side seal 120 is pressed against the intermediate transfer belt 8 with a predetermined amount thereof being embedded in the intermediate transfer belt 8 so as to prevent toner particles from scattering. Even in the belt cleaning device 100 having such a configuration, the movement speed of the intermediate transfer belt 8 is stabilized and durability is improved by reducing the load on the surface of the intermediate transfer belt 8. Within an area where the intermediate transfer belt 8 is in contact with the brush roller 101, the back surface of the intermediate transfer belt 8 is in contact with the cleaning facing roller 13 to form a cleaning nip in which a cleaning operation is reliably performed.

Since the axial end part of the cleaning facing roller 13 is disposed outside the axial end part of the brush roller 101, the occurrence of charge leakage from the axial end part of the cleaning facing roller 13 to the brush part of the brush roller 101 is prevented. If the axial end part of the cleaning facing roller 13 is disposed inside the axial end part of the brush roller 101, charge leakage is likely to occur from the edge of the axial end part of the cleaning facing roller 13 to the brush part of the brush roller 101.

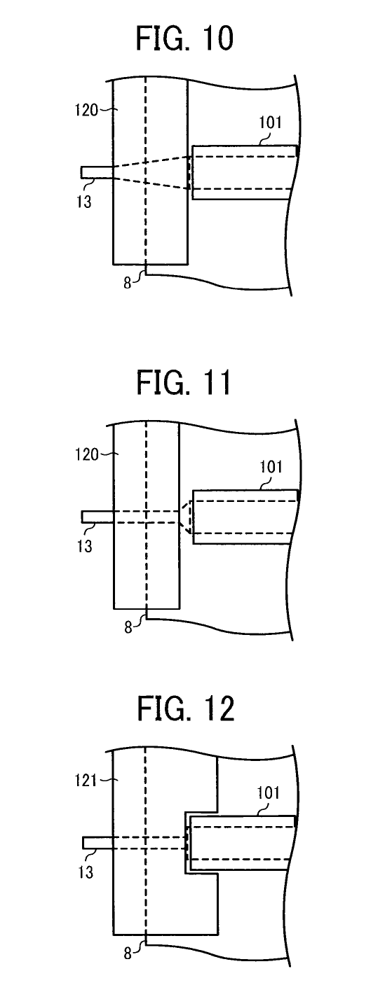

FIG. 10 is a variation of the side seal part, viewed from the inner side of the belt cleaning device. In the embodiment illustrated in FIG. 10 (hereinafter “Variation 1”), at the axial end part of the cleaning facing roller 13, an area being in contact with the side seal 120 is tapered. FIG. 11 is a variation of the side seal part, viewed from the inner side of the belt cleaning device. In the embodiment illustrated in FIG. 11 (hereinafter “Variation 2”), at the axial end part of the cleaning facing roller 13, a tapered part is formed between an area where a surface of the intermediate transfer belt 8 is in contact with the side seal 120 and another area where the back surface of the intermediate transfer belt 8 is in contact with the cleaning facing roller 13. In both Variations 1 and 2, at the axial end part of the intermediate transfer belt 8 being in contact with the side seal 120, the back surface of the intermediate transfer belt 8 is out of contact with the cleaning facing roller 13. Therefore, a surface of the intermediate transfer belt 8 passes through the contact position with the brush roller 101 with the axial end part thereof, against which the side seal 120 is pressed, being free without contacting the cleaning facing roller 13. Thus, a surface of the intermediate transfer belt 8, even having an elastic layer, can pass through the contact position with the brush roller 101 with being subjected to a reduced load. It is more effective when the surface of the intermediate transfer belt 8 is applied with a lubricant from the lubricant applicator 200 to reduce the surface friction.

Conditions of the side seal 120 are as follows.

Seal material: Foamed urethane and TEFLON (trade mark) pile

Seal thickness: 3.2 mm

Foamed urethane thickness: 2.0 mm

TEFLON pile thickness: 1.2 mm

Embedded amount to intermediate transfer belt: 1.5 mm

Overlap widths in axial direction: 9 mm (front side), 6 mm (rear side)

### Example 2

FIG. 12 is a schematic view of a side seal part of a belt cleaning device according to another embodiment (hereinafter “Example 2”), viewed from the inner side of the belt cleaning device. In Example 2, the side seal 120 of Example 1 is replaced with a side seal 121 having a concave portion. The side seal 121 can be formed by axially and inwardly extending the side seal 120 at a portion other than the contact portion with the cleaning brush roller 101. The side seal 121 having a concave portion is pressed against the intermediate transfer belt 8. Within an area where a surface of the intermediate transfer belt 8 is in contact with the brush roller 101, the back side of the intermediate transfer belt 8 is in contact with the cleaning facing roller 13 that is wider than the intermediate transfer belt 8. The axial end part of the cleaning facing roller 13 is disposed inside an area where the intermediate transfer belt 8 is in contact with the side seal 120 and outside the end part of the brush roller 101 with respect to the axial direction.

It is likely that toner particles accumulated in the belt cleaning device 100 leak from the end part of the brush roller 101. The side seal 121 having a concave portion more reliably improves sealing property. Even the contact area with the side seal 121 is enlarged, a surface of the intermediate transfer belt 8 having an elastic layer can pass through the contact position with the brush roller 101 with being subjected to a reduced load with the above configuration.

### Example 3

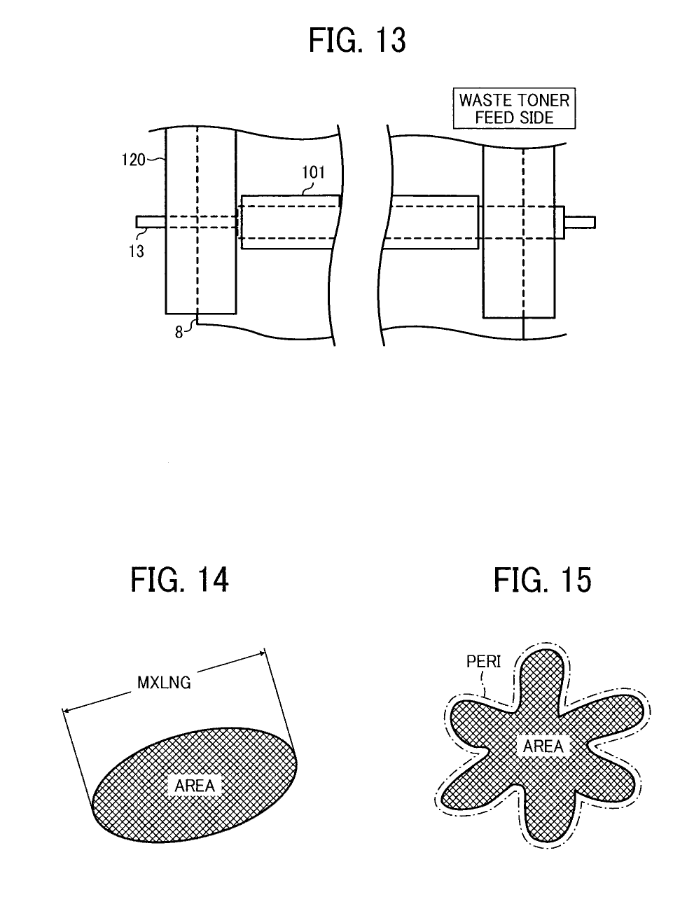

FIG. 13 is a schematic view of a side seal part of a belt cleaning device according to another embodiment (hereinafter “Example 3”), viewed from the inner side of the belt cleaning device. In Example 1, at both axial end parts of the brush roller 101 where a surface of the intermediate transfer belt 8 is in contact with the side seal 120, the cleaning facing roller 13 is out of contact with the back surface of the intermediate transfer belt 8. In Example 3, an axial end part of the cleaning facing roller 13 on a rear side, i.e., a side where waste toner particles collected by the belt cleaning device 100 are fed to a waste toner tank equipped in the main body of the image forming apparatus, is disposed outside the end part of the intermediate transfer belt 8 with respect to the axial direction. The other axial end part of the cleaning facing roller 13 on a front side is disposed inside an area where the intermediate transfer belt 8 is in contact with the side seal 120 and outside the end part of the brush roller 101 with respect to the axial direction. It is likely that toner particles accumulated in the belt cleaning device 100 leak when waste toner particles are fed to the waste toner tank. To prevent such leakage, at the axial end part on the rear side where waste toner particles are fed, the axial end part of the cleaning facing roller 13 is disposed outside the axial end part of the intermediate transfer belt 8 to improve sealing property. A surface of the intermediate transfer belt 8 having an elastic layer can pass through the contact position with the brush roller 100 with being subjected to a reduced load because only one of the axial end parts of the cleaning facing roller 13 on a front side is disposed inside the area where the intermediate transfer belt 8 is in contact with the side seal 120.

Toner usable for the image forming apparatus according to an embodiment is described in detail below.

The toner preferably has a volume average particle diameter of from 3 to 6 μm so as to reproduce micro dots having a resolution of 600 dpi or more. Preferably, the ratio (Dv/Dn) of the volume average particle diameter (Dv) to the number average particle diameter (Dn) of the toner is 1.00 to 1.40. As the ratio (Dv/Dn) approaches 1.00, the particle diameter distribution becomes narrower. Such a toner having a small particle diameter and a narrow particle diameter distribution has a uniform charge distribution, which can produce high-quality images without background fouling. In particular, such a toner exhibits high transfer efficiency in electrostatic transfer methods.

The toner preferably has a shape factor SF-1 of from 100 to 180 and another shape factor SF-2 of from 100 to 180. FIG. 14 is a schematic view illustrating a toner particle for explaining the shape factor SF-1. The shape factor SF-1 represents the degree of roundness of a toner particle, and is represented by the following formula (1):

SF-1={(MXLNG)²/AREA}×(100π)/4 (1)

wherein MXLNG represents the maximum diameter of a projected image of a toner particle on a two-dimensional plane and AREA represents the area of the projected image.

When SF-1 is 100, the toner particle has a true spherical shape. The greater the SF-1, the more irregular the toner shape.

FIG. 15 is a schematic view illustrating a toner particle for explaining the shape factor SF-2. The shape factor SF-2 represents the degree of roughness of a toner particle, and is represented by the following formula (2):

SF-2={(PERI)²/AREA}×100/(4π) (2)

wherein PERI represents the peripheral length of a projected image of a toner particle on a two-dimensional plane and AREA represents the area of the projected image.

When SF-2 is 100, the toner particle has a completely smooth surface without roughness. The greater the SF-2, the rougher the toner surface.

The shape factors are determined by obtaining a photographic image of toner particles with a scanning electron microscope (S-800 from Hitachi, Ltd.) and analyzing the photographic image with an image analyzer (LUZEX 3 from Nireco Corporation). Spherical toner particles are in point-contact with each other. Therefore, the adsorptive force between the spherical toner particles is small, resulting in high fluidity of the toner particles. Also, the adsorptive force between the toner particles and a photoreceptor is small, resulting in high transfer efficiency of the toner particles. When any one of the shape factors SF-1 and SF-2 exceeds 180, transfer efficiency may deteriorate.

The toner can be prepared by subjecting a toner composition liquid, in which a polyester prepolymer having a nitrogen-containing functional group, a polyester, a colorant, and a release agent are dissolved or dispersed in an organic solvent, to cross-linking and/or elongation reactions in an aqueous medium. Materials and manufacturing methods of the toner are described in detail below.

A polyester can be obtained from a polycondensation reaction between a polyol and a polycarboxylic acid.

The polyol (PO) may be, for example, a diol (DIO), a polyol (TO) having 3 or more valences, and a mixture thereof. A diol (DIO) alone or a mixture of a diol (DIO) with a small amount of a polyol (TO) is preferable. Specific examples of the diol (DIO) include, but are not limited to, alkylene glycols (e.g., ethylene glycol, 1,2-propylene glycol, 1,3-propylene glycol, 1,4-butanediol, 1,6-hexanediol), alkylene ether glycols (e.g., diethylene glycol, triethylene glycol, dipropylene glycol, polyethylene glycol, polypropylene glycol, polytetramethylene ether glycol), alicyclic diols (e.g., 1,4-cyclohexanedimethanol, hydrogenated bisphenol A), bisphenols (e.g., bisphenol A, bisphenol F, bisphenol S), alkylene oxide (e.g., ethylene oxide, propylene oxide, butylene oxide) adducts of the alicyclic diols, and alkylene oxide (e.g., ethylene oxide, propylene oxide, butylene oxide) adducts of the bisphenols. Among these diols, alkylene glycols having 2 to 12 carbon atoms and alkylene oxide adducts of bisphenols are preferable; and alkylene oxide adducts of bisphenols and mixtures of an alkylene oxide adducts of bisphenol with an alkylene glycol having 2 to 12 carbon atoms are more preferable. Specific examples of the polyol (TO) having 3 or more valences include, but are not limited to, polyvalent aliphatic alcohols having 3 or more valences (e.g., glycerin, trimethylolethane, trimethylolpropane, pentaerythritol, sorbitol), polyphenols having 3 or more valences (e.g., trisphenol PA, phenol novolac, cresol novolac), and alkylene oxide adducts of the polyphenols having 3 or more valences.

The polycarboxylic acid (PC) may be, for example, a dicarboxylic acid (DIC), a polycarboxylic acid (TC) having 3 or more valences, and a mixture thereof. A dicarboxylic acid (DIC) alone or a mixture of a dicarboxylic acid (DIC) with a small amount of a polycarboxylic acid (TC) is preferable. Specific examples of the dicarboxylic acid (DIC) include, but are not limited to, alkylene dicarboxylic acids (e.g., succinic acid, adipic acid, sebacic acid), alkenylene dicarboxylic acids (e.g., maleic acid, fumaric acid), and aromatic dicarboxylic acids (e.g., phthalic acid, isophthalic acid, terephthalic acid, naphthalenedicarboxylic acid). Among these dicarboxylic acids, alkenylene dicarboxylic acids having 4 to 20 carbon atoms and aromatic dicarboxylic acids having 8 to 20 carbon atoms are preferable. Specific examples of the polycarboxylic acid (TC) having 3 or more valences include, but are not limited to, aromatic polycarboxylic acids having 9 to 20 carbon atoms (e.g., trimellitic acid, pyromellitic acid). Additionally, anhydrides and lower alkyl esters (e.g., methyl ester, ethyl ester, isopropyl ester) of the above-described polycarboxylic acids are also usable as the polycarboxylic acid (PC). The equivalent ratio [OH]/[COOH] of hydroxyl groups [OH] in the polyol (PO) to carboxyl groups [COOH] in the polycarboxylic acid (PC) is preferably 2/1 to 1/1, more preferably 1.5/1 to 1/1, and most preferably 1.3/1 to 1.02/1. The polyol (PO) and the polycarboxylic acid (PC) are subjected to a polycondensation reaction by being heated to 150 to 280° C. in the presence of an esterification catalyst (e.g., tetrabutoxy titanate, dibutyltin oxide), while optionally reducing pressure and removing the produced water, to obtain a polyester having a hydroxyl group. The polyester preferably has a hydroxyl value of 5 or more; and an acid value of 1 to 30, more preferably 5 to 20. Polyesters having a certain acid value are negatively chargeable and have affinity for paper, resulting in improvement of low-temperature fixability. When the acid value exceeds 30, the resulting toner charge may be unstable in terms of environmental variation. The polyester preferably has a weight average molecular weight of from 10,000 to 400,000, more preferably from 20,000 to 200,000. When the weight average molecular weight is less than 10,000, hot offset resistance of the resulting toner may be poor. When the weight average molecular weight exceeds 400,000, low-temperature fixability of the resulting toner may be poor.

The polyester may further include a urea-modified polyester other than an unmodified polyester obtainable from the above-described polycondensation reaction. The urea-modified polyester can be obtained by reacting terminal carboxyl or hydroxyl groups of the above-prepared polyester with a polyisocyanate (PIC) to prepare a polyester prepolymer (A) having an isocyanate group, and reacting the polyester prepolymer (A) with an amine to cross-link or elongate molecular chains. Specific examples of the polyisocyanate (PIC) include, but are not limited to, aliphatic polyisocyanates (e.g., tetramethylene diisocyanate, hexamethylene diisocyanate, 2,6-diisocyanatomethyl caproate), alicyclic polyisocyanates (e.g., isophorone diisocyanate, cyclohexylmethane diisocyanate), aromatic diisocyanates (e.g., tolylene diisocyanate, diphenylmethane diisocyanate), aromatic aliphatic diisocyanates (e.g., α,α,α′,α′-tetramethylxylylene diisocyanate), isocyanurates, and the above polyisocyanates in which the isocyanate group is blocked with a phenol derivative, an oxime, or a caprolactam. Two or more of these compounds can be used in combination. The equivalent ratio [NCO]/[OH] of isocyanate groups [NCO] in the polyisocyanate (PIC) to hydroxyl groups [OH] in the polyester having a hydroxyl group is preferably 5/1 to 1/1, more preferably 4/1 to 1.2/1, and most preferably from 2.5/1 to 1.5/1. When the equivalent ratio [NCO]/[OH] exceeds 5/1, low-temperature fixability of the resulting toner may be poor. When the equivalent ratio [NCO]/[OH] is less than 1/1, hot offset resistance of the resulting toner may be poor because the content of urea in the polyester prepolymer is too small. The polyester prepolymer (A) having an isocyanate group includes the polyisocyanate (PIC) units in an amount of 0.5 to 40% by weight, more preferably 1 to 30% by weight, and most preferably 2 to 20% by weight. When the ratio of the polyisocyanate (PIC) units is less than 0.5% by weight, hot offset resistance, heat-resistant storage stability, and low-temperature fixability of the resulting toner may be poor. When the ratio of the polyisocyanate (PIC) units exceeds 40% by weight, low-temperature fixability of the resulting toner may be poor. The average number of isocyanate groups included in one molecule of the polyester prepolymer (A) having an isocyanate group is preferably 1 or more, more preferably 1.5 to 3, and most preferably 1.8 to 2.5. When the number of isocyanate groups per molecule is too small, hot offset resistance of the toner may be poor because the molecular weight of the resulting urea-modified polyester is too small.

The amine (B) to be reacted with the polyester prepolymer (A) may be, for example, a diamine (B1), a polyamine (B2) having 3 or more valences, an amino alcohol (B3), an amino mercaptan (B4), an amino acid (B5), or a blocked amine (B6) in which the amino group in any of the amines (B1) to (B5) is blocked.

Specific examples of the diamine (B1) include, but are not limited to, aromatic diamines (e.g., phenylenediamine, diethyltoluenediamine, 4,4′-diaminodiphenylmethane), alicyclic diamines (e.g., 4,4′-diamino-3,3′-dimethyldicyclohexylmethane, diaminocyclohexane, isophoronediamine), and aliphatic diamines (e.g., ethylenediamine, tetramethylenediamine, hexamethylenediamine). Specific examples of the polyamine (B2) having 3 or more valences include, but are not limited to, diethylenetriamine and triethylenetetramine. Specific examples of the amino alcohol (B3) include, but are not limited to, ethanolamine and hydroxyethylaniline. Specific examples of the amino mercaptan (B4) include, but are not limited to, aminoethyl mercaptan and aminopropyl mercaptan. Specific examples of the amino acid (B5) include, but are not limited to, aminopropionic acid and aminocaproic acid. Specific examples of the blocked amine (B6) include, but are not limited to, ketimine compounds obtained from the above-described amines (B1) to (B5) and ketones (e.g., acetone, methyl ethyl ketone, methyl isobutyl ketone), and oxazoline compounds. Among these amines (B), a diamine (B1) alone and a mixture of a diamine (B1) with a small amount of a polyamine (B2) having 3 or more valences are preferable.

The equivalent ratio [NCO]/[NHx] of isocyanate groups [NCO] in the polyester prepolymer (A) to amino groups [NHx] in the amine (B) is preferably 1/2 to 2/1, more preferably 1.5/1 to 1/1.5, and most preferably 1.2/1 to 1/1.2. When the equivalent ratio [NCO]/[NHx] is too large or small, hot offset resistance of the resulting toner may be poor because the molecular weight of the resulting urea-modified polyester is too small.

The urea-modified polyester may include urethane bonds other than urea bonds. In this case, the molar ratio of urea bonds to urethane bonds is preferably 100/0 to 10/90, more preferably 80/20 to 20/80, and most preferably 60/40 to 30/70. When the molar ratio of urea bonds is too small, hot offset resistance of the resulting toner may be poor.

The urea-modified polyester may be prepared by one-shot method. First, the polyol (PO) and the polycarboxylic acid (PC) are heated to 150 to 280° C. in the presence of an esterification catalyst (e.g., tetrabutoxy titanate, dibutyltin oxide), while optionally reducing pressure and removing the produced water, to obtain a polyester having a hydroxyl group. Next, the polyester having a hydroxyl group is reacted with a polyisocyanate (PIC) at 40 to 140° C., to obtain a polyester prepolymer (A) having an isocyanate group. The polyester prepolymer (A) is further reacted with the amine (B) at 0 to 140° C., to obtain a urea-modified polyester.

When reacting the polyisocyanate (PIC), or reacting the polyester prepolymer (A) with the amine (B), solvents can be used, if needed. Specific examples of usable solvents include, but are not limited to, aromatic solvents (e.g., toluene, xylene), ketones (e.g., acetone, methyl ethyl ketone, methyl isobutyl ketone), esters (e.g., ethyl acetate), amides (e.g., dimethylformamide, dimethylacetamide), and ethers (e.g., tetrahydrofuran), which are inactive against the polyisocyanate (PIC).

The cross-linking and/or elongation reaction between the polyester prepolymer (A) and the amine (B) can be terminated with a reaction terminator, if needed, to control the molecular weight of the resulting urea-modified polyester. Specific examples of suitable reaction terminators include, but are not limited to, monoamines (e.g., diethylamine, dibutylamine, butylamine, laurylamine) and blocked monoamines (e.g., ketimine compounds).

The urea-modified polyester preferably has a weight average molecular weight of 10,000 or more, more preferably 20,000 to 10,000,000, and most preferably 30,000 to 1,000,000. When the weight average molecular weight is less than 10,000, hot offset resistance of the resulting toner may be poor. The urea-modified polyester is not limited in number average molecular weight when used in combination with the above-described unmodified polyester. When the urea-modified polyester is used alone, the urea-modified polyester preferably has a number average molecular weight of 2,000 to 15,000, more preferably 2,000 to 10,000, and most preferably 2,000 to 8,000. When the number average molecular weight exceeds 20,000, low-temperature fixability of the resulting toner may be poor and the resulting image may have low gloss.

The combination of the unmodified polyester and the urea-modified polyester provides better low-temperature fixability and gloss compared to a case in which the urea-modified polyester is used alone. The unmodified polyester may include a polyester modified with a chemical bond other than urea bond.

It is preferable that the unmodified polyester and the urea-modified polyester are at least partially compatible with each other from the viewpoint of low-temperature fixability and hot offset resistance of the toner. Therefore, the unmodified polyester and the urea-modified polyester preferably have a similar chemical composition.

The weight ratio of the unmodified polyester to the urea-modified polyester is preferably 20/80 to 95/5, more preferably 70/30 to 95/5, much more preferably 75/25 to 95/5, and most preferably 80/20 to 93/7. When the ratio of the unmodified polyester is too small, hot offset resistance, heat-resistant storage stability, and low-temperature fixability of the resulting toner may be poor.

A binder resin including both the unmodified polyester and the urea-modified polyester has a glass transition temperature (Tg) of 45 to 65° C., more preferably 45 to 60° C. When the glass transition temperature is less than 45° C., heat resistance of the resulting toner may be poor. When the glass transition temperature exceeds 65° C., low-temperature fixability of the resulting toner may be poor.

The resulting toner has better heat-resistant storage stability than typical polyester-based toners even when the toner has a low glass transition temperature, because the urea-modified polyester tends to exist at the surface of the toner particles.

Specific examples of usable colorants include, but are not limited to, carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR1, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red FSR, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, and lithopone. Two or more of these colorants can be used in combination. The content of the colorant in the toner is preferably 1 to 15% by weight, and more preferably 3 to 10% by weight. The content of the colorant in the toner is preferably 1 to 15% by weight, and more preferably 3 to 10% by weight.

The colorant can be combined with a resin to be used as a master batch. Specific examples of usable resins for the master batch include, but are not limited to, styrene-based polymers (e.g., polystyrene, poly-p-chlorostyrene, polyvinyl toluene), copolymers of the styrene-based polymers with vinyl compounds, polymethyl methacrylate, polybutyl methacrylate, polyvinyl chloride, polyvinyl acetate, polyethylene, polypropylene, epoxy resin, epoxy polyol resin, polyurethane, polyamide, polyvinyl butyral, polyacrylic acid resin, rosin, modified rosin, terpene resin, aliphatic or alicyclic hydrocarbon resin, aromatic petroleum resin, chlorinated paraffin, and paraffin wax. Two or more of these resins can be used in combination.

Specific examples of suitable charge controlling agents include, but are not limited to, nigrosine dyes, triphenylmethane dyes, chromium-containing metal complex dyes, chelate pigments of molybdic acid, Rhodamine dyes, alkoxyamines, quaternary ammonium salts (including fluorine-modified quaternary ammonium salts), alkylamides, phosphor and phosphor-containing compounds, tungsten and tungsten-containing compounds, fluorine activators, metal salts of salicylic acid, and metal salts of salicylic acid derivatives. Specific examples of commercially available charge controlling agents include, but are not limited to, BONTRON® 03 (nigrosine dye), BONTRON® P-51 (quaternary ammonium salt), BONTRON® S-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complexes of quaternary ammonium salts), which are manufactured by Hodogaya Chemical Co., Ltd.; COPY CHARGER PSY VP2038 (quaternary ammonium salt), COPY BLUER PR (triphenyl methane derivative), COPY CHARGE® NEG VP2036 and COPY CHARGE® NX VP434 (quaternary ammonium salts), which are manufactured by Hoechst AG; LR1-901, and LR-147 (boron complex), which are manufactured by Japan Carlit Co., Ltd.; and cooper phthalocyanine, perylene, quinacridone, azo pigments, and polymers having a functional group such as a sulfonate group, a carboxyl group, and a quaternary ammonium group. In particular, compounds which can control toner to have a negative polarity are preferable.

The content of the charge controlling agent is determined based on the kind of binder resin used, the presence or absence of other additives, and how the toner is manufactured. Preferably, the content of the charge controlling agent is 0.1 to 10 parts by weight, more preferably 0.2 to 5 parts by weight, based on 100 parts by weight of the binder resin, but is not limited thereto. When the content of charge controlling agent is too large, the toner may be excessively charged and thereby electrostatically attracted to a developing roller, resulting in poor fluidity of the developer and low image density.

The toner may include a wax having a low melting point of 50 to 120° C. as a release agent. Such a wax effectively functions as the release agent at an interface between a fixing roller and the toner. Thus, there is no need to apply a release oil to the fixing roller. Specific examples of suitable waxes include, but are not limited to, natural waxes such as plant waxes (e.g., carnauba wax, cotton wax, sumac wax, rice wax), animal waxes (e.g., bees wax, lanolin), mineral waxes (e.g., ozokerite, ceresin), and petroleum waxes (e.g., paraffin wax, micro-crystalline wax, petrolatum wax); synthetic hydrocarbon waxes such as Fischer-Tropsch wax and polyethylene wax; and synthetic waxes of esters, ketone, and ethers. Further, the following materials are also usable for the release agent: fatty acid amides such as 1,2-hydroxystearic acid amide, stearic acid amide, phthalic anhydride imide, and chlorinated hydrocarbon; and crystalline polyesters having a long alkyl side chain, such as poly-n-stearyl methacrylate and poly-n-lauryl methacrylate, which are a homopolymer or a copolymer of polyacrylates (e.g., n-stearyl polymethacrylate, n-lauryl polymethacrylate).

The charge controlling agent and release agent may be directly mixed with the binder resin or the master batch, or added to an organic solvent containing such toner components.

The toner may further include a particulate inorganic material on the surface thereof to improve fluidity, developability, and chargeability. The particulate inorganic material preferably has a primary particle diameter of 5×10⁻³ to 2 μm, and more preferably 5×10⁻³ to 0.5 μm. The particulate inorganic material preferably has a BET specific surface of 20 to 500 m²/g. The content of the particulate inorganic material in the toner is preferably 0.01 to 5% by weight, and more preferably 0.01 to 2.0% by weight. Specific preferred examples of suitable particulate inorganic materials include, but are not limited to, silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, and silicon nitride. In particular, a mixture of hydrophobized silica particles and hydrophobized titanium oxide particles is suitable as a fluidizer. Specifically, a mixture of hydrophobized silica particles and hydrophobized titanium oxide particles both having an average particle diameter of 5×10⁻⁴ μm or less can be reliably held on the toner surface with improved electrostatic force and van der Waals force even when the toner is repeatedly agitated in a developing device, thereby producing high-quality image and reducing residual toner particles which are not transferred. Titanium oxide particles have advantages in terms of environmental stability and image density stability, however, they have a disadvantage in terms of charge rising ability. Thus, too large a mixing ratio of titanium oxide particles to silica particles is disadvantageous. When the contents of hydrophobized silica particles and hydrophobized titanium oxide particles are 0.3 to 1.5% by weight, charge rising ability is not so deteriorated that high image quality can be reliably produced for an extended period of time.

An exemplary method of manufacturing the toner is described below.

(1) A toner components liquid is prepared by dispersing or dissolving a colorant, an unmodified polyester, a polyester prepolymer having an isocyanate group, and a release agent in an organic solvent.

Preferably, the organic solvent is a volatile solvent having a boiling point less than 100° C., which is easily removable from the resulting particles. Specific examples of such solvents include, but are not limited to, toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. Two or more of these solvents can be used in combination. Among these solvents, aromatic solvents (e.g., toluene, xylene) and halogenated hydrocarbons (e.g., methylene chloride, 1,2-dichloroethane, chloroform, carbon tetrachloride) are preferable. The amount of the solvent is preferably 0 to 300 parts by weight, more preferably 0 to 100 parts by weight, and most preferably 25 to 70 parts by weight, based on 100 parts by weight of the polyester prepolymer.

(2) The toner components liquid is emulsified in an aqueous medium in the presence of a surfactant and a particulate resin.

The aqueous medium may be, for example, water alone, or a mixture of water with an alcohol (e.g., methanol, isopropyl alcohol, ethylene glycol), dimethylformamide, tetrahydrofuran, a cellosolve (e.g., methyl cellosolve), or a lower ketone (e.g., acetone, methyl ethyl ketone).

The amount of the aqueous medium is preferably 50 to 2,000 parts by weight, more preferably 100 to 1,000 parts by weight, based on 100 parts by weight of the toner components liquid. When the amount of the aqueous medium is less than 50 parts, the toner components may not be finely dispersed, and the resulting toner particles may not have a desired particle size. When the amount of the aqueous medium exceeds 20,000, manufacturing cost may increase.

To improve dispersing ability, a dispersant, such as a surfactant and a particulate resin, is added to the aqueous medium.

Specific preferred examples of suitable surfactants include, but are not limited to, anionic surfactants such as α-olefin sulfonate and phosphates; cationic surfactants such as amine salt type surfactants (e.g., alkylamine salts, amino alcohol fatty acid derivatives, polyamine fatty acid derivatives, imidazoline) and quaternary ammonium salt type surfactants (e.g., alkyl trimethyl ammonium salt, dialkyl dimethyl ammonium salt, alkyl dimethyl benzyl ammonium salt, pyridinium salt, alkyl isoquinolinium salt, and benzethonium chloride); nonionic surfactants such as fatty acid amide derivatives and polyvalent alcohol derivatives; and ampholytic surfactants such as alanine, dodecyldi(aminoethyl)glycine, and N-alkyl-N,N-dimethyl ammonium betaine.

Surfactants having a fluoroalkyl group can achieve an effect in a small amount. Specific preferred examples of suitable anionic surfactants having a fluoroalkyl group include, but are not limited to, fluoroalkyl carboxylic acids having 2 to 10 carbon atoms and metal salts thereof, perfluorooctane sulfonyl glutamic acid disodium, 3-[ω-fluoroalkyl(C6-C11)oxy]-1-alkyl(C3-C4) sulfonic acid sodium, 3-[ω-fluoroalkanoyl(C6-C8)-N-ethylamino]-1-propane sulfonic acid sodium, fluoroalkyl(C11-C20) carboxylic acids and metal salts thereof, perfluoroalkyl(C7-C13) carboxylic acids and metal salts thereof, perfluoroalkyl(C4-C12) sulfonic acids and metal salts thereof, perfluorooctane sulfonic acid dimethanol amide, N-propyl-N-(2-hydroxyethyl)perfluorooctane sulfonamide, perfluoroalkyl(C6-C10) sulfonamide propyl trimethyl ammonium salts, perfluoroalkyl(C6-C10)-N-ethyl sulfonyl glycine salts, and monoperfluoroalkyl(C6-C16) ethyl phosphates.

Specific examples of commercially available such anionic surfactants having a fluoroalkyl group include, but are not limited to, SURFLON® S-111, S-112, and S-113 (from AGC Seimi Chemical Co., Ltd.); FLUORAD FC-93, FC-95, FC-98, and FC-129 (from Sumitomo 3M); UNIDYNE DS-101 and DS-102 (from Daikin Industries, Ltd.); MEGAFACE F-110, F-120, F-113, F-191, F-812, and F-833 (from DIC Corporation); EFTOP EF-102, 103, 104, 105, 112, 123A, 123B, 306A, 501, 201, and 204 (from Mitsubishi Materials Electronic Chemicals Co., Ltd.); and FTERGENT F-100 and F-150 (from Neos Company Limited).

Specific preferred examples of suitable cationic surfactants having a fluoroalkyl group include, but are not limited to, aliphatic primary, secondary, and tertiary amine acids having a fluoroalkyl group, aliphatic quaternary ammonium salts such as perfluoroalkyl(C6-C10) sulfonamide propyl trimethyl ammonium salts, benzalkonium salts, benzethonium chlorides, pyridinium salts, and imidazolinium salts. Specific examples of commercially available cationic surfactants having a fluoroalkyl group include, but are not limited to, SURFLON® S-121 (from AGC Seimi Chemical Co., Ltd.); FLUORAD FC-135 (from Sumitomo 3M); UNIDYNE DS-202 (from Daikin Industries, Ltd.); MEGAFACE F-150 and F-824 (from DIC Corporation); EFTOP EF-132 (from Mitsubishi Materials Electronic Chemicals Co., Ltd.); and FTERGENT F-300 (from Neos Company Limited).

The particulate resin stabilizes mother toner particles formed in the aqueous medium. An appropriate amount of the particulate resin is added to the aqueous medium so that the coverage of the particulate resin on the surfaces of the mother toner particles becomes 10 to 90%. For example, the particulate resin may be a particulate polymethyl methacrylate having a particle diameter of 1 or 3 μm, a particulate polystyrene having a particle diameter of 0.5 or 2 μm, or a particulate poly(styrene-acrylonitrile) having a particle diameter of 1 μm. Specific examples of commercially available particulate resins include, but are not limited to, PB-200H (from Kao Corporation), SGP (from Soken Chemical & Engineering Co., Ltd.), TECHPOLYMER SB (from Sekisui Plastics Co., Ltd.), SGP-3G (from Soken Chemical & Engineering Co., Ltd.), and MICROPEARL (from Sekisui Chemical Co., Ltd.). Additionally, inorganic dispersants such as tricalcium phosphate, calcium carbonate, titanium oxide, colloidal silica, and hydroxyapatite are also usable.

Polymeric protection colloids can be used in combination with the above-described particulate resins and inorganic dispersants to more stabilize liquid droplets in the dispersion. Specific examples of usable polymeric protection colloids include, but are not limited to, homopolymers and copolymers obtained from monomers, such as acids (e.g., acrylic acid, methacrylic acid, α-cyanoacrylic acid, α-cyanomethacrylic acid, itaconic acid, crotonic acid, fumaric acid, maleic acid, maleic anhydride), hydroxyl-group-containing acrylates and methacrylates (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethylene glycol monoacrylate, diethylene glycol monomethacrylate, glycerin monoacrylate, glycerin monomethacrylate), vinyl alcohols and vinyl alcohol ethers (e.g., vinyl methyl ether, vinyl ethyl ether, vinyl propyl ether), esters of vinyl alcohols with carboxyl-group-containing compounds (e.g., vinyl acetate, vinyl propionate, vinyl butyrate), amides (e.g., acrylamide, methacrylamide, diacetone acrylamide) and methylol compounds thereof (e.g., N-methylol acrylamide, N-methylol methacrylamide), acid chlorides (e.g., acrylic acid chloride, methacrylic acid chloride), and monomers containing nitrogen or a nitrogen-containing heterocyclic ring (e.g., vinyl pyridine, vinyl pyrrolidone, vinyl imidazole, ethylene imine); polyoxyethylenes (e.g., polyoxyethylene, polyoxypropylene, polyoxyethylene alkylamine, polyoxypropylene alkylamine, polyoxyethylene alkylamide, polyoxypropylene alkylamide, polyoxyethylene nonyl phenyl ether, polyoxyethylene lauryl phenyl ether, polyoxyethylene stearyl phenyl ester, polyoxyethylene nonyl phenyl ester); and celluloses (e.g., methyl cellulose, hydroxyethyl cellulose, hydroxypropyl cellulose).

The toner components liquid is dispersed in the aqueous medium using a low-speed shearing disperser, a high-speed shearing disperser, a frictional disperser, a high-pressure jet disperser, or an ultrasonic disperser, for example. A high-speed shearing disperser is preferable when controlling the particle diameter of the dispersing liquid droplets into 2 to 20 μm. As for the high-speed shearing disperser, the revolution is preferably 1,000 to 30,000 rpm, and more preferably 5,000 to 20,000 rpm. The dispersing time is preferably 0.1 to 5 minutes for a batch type. The dispersing temperature is preferably 0 to 150° C. (under pressure), and more preferably 40 to 98° C.

(3) At the time of emulsification, an amine (b) is added to the aqueous medium so that the amine (B) reacts with the polyester prepolymer (A) to cross-link or elongate their molecular chains.

The reaction time between the prepolymer (A) and the amine (B) is preferably 10 minutes to 40 hours, and more preferably from 2 to 24 hours. The reaction temperature is preferably 0 to 150° C., and more preferably 40 to 98° C. A catalyst can be used, if needed. Specific examples of usable catalyst include, but are not limited to, dibutyltin laurate and dioctyltin laurate.

(4) After termination of the reaction, the organic solvent is removed from the emulsion (i.e., reaction products), followed by washing and drying, to obtain mother toner particles.

To remove the organic solvent, the emulsion is gradually heated while being agitated with a laminar airflow. In particular, the organic solvent is removed after the emulsion is strongly agitated within a certain temperature range so that the resulting mother toner particles have a spindle shape. In a case in which a dispersant soluble in acids and bases (e.g., calcium phosphate) is used, the resulting toner particles are first washed with an acid (e.g., hydrochloric acid) and then washed with water to remove the dispersant. Alternatively, such a dispersant can be removed with an enzyme.

(5) The surfaces of the mother toner particles are treated with a charge controlling agent and inorganic particles, such as silica particles and titanium oxide particles, to obtain toner particles. More specifically, the charge controlling agent and the inorganic particles are externally added to the surfaces of the mother toner particles using a mixer.

Thus, toner particles having a small particle diameter and a narrow particle diameter distribution can be obtained. Strong agitation in the solvent removal process makes the resulting particles have a variety of shapes, from a spherical shape to a rugby ball shape, and a variety of surface conditions, from a smooth surface to a dimpled surface.

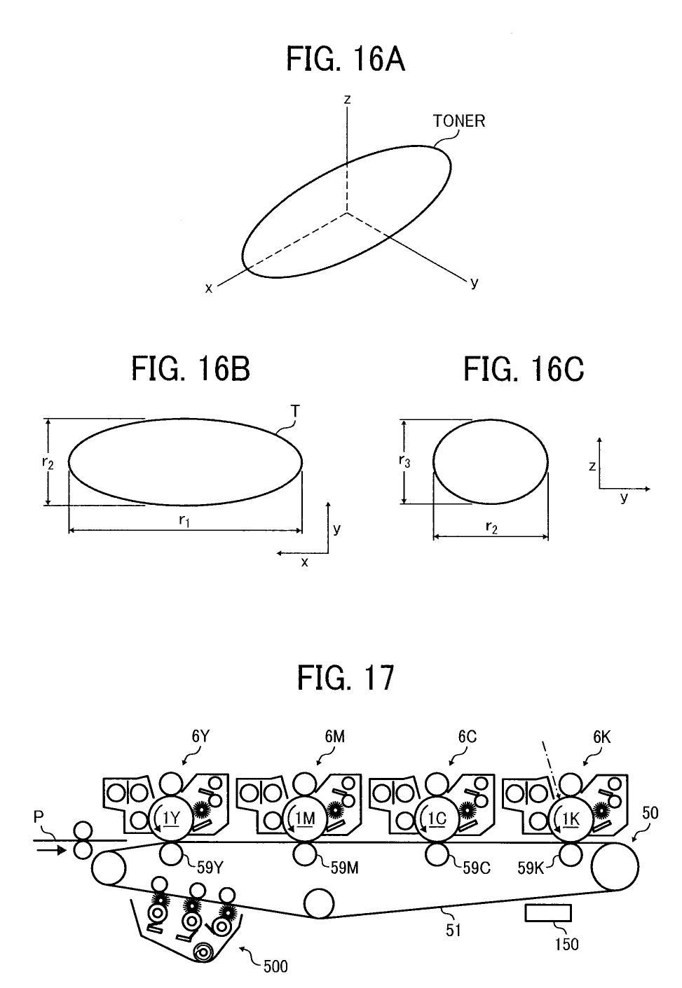

The toner has a substantially spherical shape represented by the following shape factors. FIGS. 16A, 16B, and 16C are schematic views illustrating a toner particle. The long axis, short axis, and thickness of the toner particle are represented by r1, r2, and r3, respectively, and a formula r1≧r2≧r3 is satisfied. Referring to FIG. 16B, the ratio (r2/r1) of the short axis r2 to the long axis r1 is preferably 0.5 to 1.0. Referring to FIG. 16C, the ratio (r3/r2) of the thickness r3 to the short axis r2 is preferably 0.7 to 1.0. When the ratio (r2/r1) of the short axis r2 to the long axis r1 is less than 0.5, it means that the toner particle has a shape far from a sphere. Such toner particle does not produce high quality image because of having poor dot reproducibility and transfer efficiency. When the ratio (r3/r2) of the thickness r3 to the short axis r2 is less than 0.7, it means that the toner particle has a flat shape. Such toner particle does not provide high transfer efficiency unlike spherical toner particles. When the ratio (r3/r2) of the thickness r3 to the short axis r2 is 1.0, it means that the toner particle is a body of rotation, the rotational axis of which is the long axis. Such toner particles have high fluidity.

The long axis r1, short axis r2, and thickness r3 are measured from photographs obtained using a scanning electron microscope (SEM) while varying the view angle.

In the above-described embodiments, the intermediate transfer belt 8 having an elastic layer is cleaned by the belt cleaning device 100 having three cleaning brush rollers. However, the structure of the intermediate transfer belt or the number of the cleaning brush rollers is not limited thereto.

FIG. 17 is a schematic view illustrating an image forming apparatus according to another embodiment of the invention, including a cleaning device 500 including a paper conveyance belt 51. The image forming apparatus illustrated in FIG. 17 employs a tandem direct transfer method in which the paper conveyance belt 51 is in contact with the photoreceptors 1Y, 1M, 1C, and 1K to form primary transfer nips for yellow, magenta, cyan, and black toner images, respectively. The paper conveyance belt 51 conveys the recording medium P held on its surface from the left toward the right in FIG. 17 to feed it into the primary transfer nips during its endless movement. Thus, toner images of yellow, magenta, cyan, and black are superimposed on and transferred onto the recording medium P.

Provision of an elastic layer to the paper conveyance belt 51 improves transferability. After passing the primary transfer nip for black toner image, the paper conveyance belt 51 is cleaned by the conveyance belt cleaning device 500. An optical sensor unit 150 is disposed facing an outer peripheral surface of the paper conveyance belt 51 forming a predetermined gap therebetween. The image forming apparatus executes an image density control and a position deviation correction at a predetermined timing and forms predetermined toner patterns (e.g., gradation patterns, Chevron patches) on the paper conveyance belt 51. The control or correction is executed based on the detection results from the optical sensor unit 150. After the optical sensor unit 150 detects the toner patterns, the conveyance belt cleaning device 500 removes the toner patterns from the paper conveyance belt 51. The paper conveyance belt 51 has a function of bearing a toner image.

The conveyance belt cleaning device 500 can reliably removes toner patterns formed on the paper conveyance belt 51 and prevents the back surface of the recording medium from being contaminated with toner. Even when the belt cleaning device 500 is equipped with a side seal for preventing toner particles from scattering, the movement speed of the paper conveyance belt is stabilized and durability thereof is improved by reducing the load thereon.

All kinds of belt cleaning devices having a configuration in which a cleaning member is in contact with a surface of an image bearing belt having an elastic layer while facing a cleaning facing member that is one of multiple tension members stretching the image bearing belt taut, so that a cleaning nip is formed between the cleaning member and the image bearing member, are applicable and provides the same effects regardless of the charging method. The charging method thereof is not limited to an electrostatic method.

Image forming apparatuses including a photoreceptor belt having an elastic layer as an image bearing belt are also applicable.

According to an embodiment (hereinafter “Embodiment A”), an image forming apparatus is provided including the belt cleaning device 100 including: an image bearing belt, such as the intermediate transfer belt 8; a cleaning member in contact with a surface of the image bearing belt to electrostatically remove a substance adhered thereto, such as the brush roller 101; a facing member disposed on the back-surface side of the image bearing belt while facing the cleaning member with the image bearing belt therebetween, such as the cleaning facing roller 13; and the side seal 120 disposed to an axial end part of the cleaning member while being in contact with the surface of the image bearing belt. In this image forming apparatus, the facing member is out of contact with the back surface of the image bearing belt within an area where the facing member faces the side seal with respect to the axial direction. According to this embodiment, the occurrence of toner scattering is prevented because the side seal is pressed against the surface of the image bearing belt while the load on the image bearing belt is reduced. Thus, the apparatus can provide excellent cleanability and high image quality for an extended period of time.

According to another embodiment (hereinafter “Embodiment B”), the cleaning member of the belt cleaning device 100 according to Embodiment A includes a normally-charged toner cleaning member to electrostatically remove normally-charged toner particles on a cleaning target while being applied with a voltage having the opposite polarity to the normal polarity of toner, such as the normally-charged toner cleaning brush roller 107; and an oppositely-charged toner cleaning member to electrostatically remove oppositely-charged toner particles on the image bearing belt while being applied with a voltage having the same polarity as the normal polarity of toner, disposed upstream from the normally-charged toner cleaning member relative to the direction of surface movement of the image bearing belt, such as the oppositely-charged toner cleaning brush roller 104. The belt cleaning device 100 further includes a pre-cleaning member to electrostatically remove normally-charged toner particles while being applied with a voltage having the opposite polarity to the normal polarity of toner, disposed upstream from the normally-charged toner cleaning member and oppositely-charged toner cleaning member relative to the direction of surface movement of the image bearing belt, such as the pre-cleaning brush roller 101. In this embodiment, even when an untransferred toner image is input into the belt cleaning device, the untransferred toner image can be reliably removed from the image bearing belt.

According to another embodiment (hereinafter “Embodiment C”), the image bearing belt of Embodiment A or B is an intermediate transfer belt onto which multiple toner images formed on a latent image bearing member are to be sequentially transferred and superimposed on one another. According to this embodiment, such a full-color image forming apparatus employing an intermediate transfer method can provide excellent cleanability and high image quality for an extended period of time.

According to another embodiment (hereinafter “Embodiment D”), the image bearing belt of Embodiment A or B is a transfer conveyance belt, a surface of which is adapted to bear a recording medium onto which multiple toner images formed on a latent image bearing member are sequentially transferred and superimposed on one another. According to this embodiment, such a full-color image forming apparatus employing a direct transfer method can provide excellent cleanability and high image quality for an extended period of time.

According to another embodiment (hereinafter “Embodiment E”), the substance adhered to the image bearing belt in Embodiment A, B, C, or D is a toner having a shape factor of from 100 to 150. According to this embodiment, high image quality is provided for an extended period of time.

Additional modifications and variations in accordance with further embodiments of the present invention are possible in light of the above teachings. It is therefore to be understood that within the scope of the appended claims the invention may be practiced other than as specifically described herein.

What is claimed is:

1. An image forming apparatus, comprising:
a belt cleaning device including:
an image bearing belt having an elastic layer, a surface of the image bearing belt being movable;
a cleaning member, the cleaning member being in contact with the surface of the image bearing belt to remove a substance adhered thereto;
a cleaning facing member, the cleaning facing member being disposed on a back-surface side of the image bearing belt while facing the cleaning member with the image bearing belt therebetween; and
a side seal, the side seal being disposed to an axial end part of the cleaning member and pressed against the surface of the image bearing belt,
wherein the cleaning facing member is out of contact with the back side of the image bearing belt within an area where the cleaning facing member faces the side seal with respect to an axial direction.

2. The image forming apparatus according to claim 1, wherein the cleaning member includes:
a normally-charged toner cleaning member adapted to electrostatically remove normally-charged toner particles on the image bearing belt while being applied with a voltage having the opposite polarity to a normal polarity of toner;
an oppositely-charged toner cleaning member adapted to electrostatically remove oppositely-charged toner particles on the image bearing belt while being applied with a voltage having the same polarity as the normal polarity of toner, the oppositely-charged toner cleaning member being disposed upstream from the normally-charged toner cleaning member relative to the direction of surface movement of the image bearing belt; and
a pre-cleaning member adapted to electrostatically remove normally-charged toner particles on the image bearing belt while being applied with a voltage having the opposite polarity to the normal polarity of toner, the pre-cleaning member being disposed upstream from the normally-charged toner cleaning member and the oppositely-charged toner cleaning member relative to the direction of surface movement of the image bearing belt.

3. The image bearing member according to claim 1, wherein the image bearing belt is an intermediate transfer belt onto which multiple toner images formed on an electrostatic latent image are to be sequentially transferred and superimposed on one another.

4. The image bearing member according to claim 1, wherein the image bearing belt is a transfer conveyance belt, a surface of which being adapted to bear a recording medium onto which multiple toner images formed on an electrostatic latent image are to be sequentially transferred and superimposed on one another.

5. The image forming apparatus according to claim 1, wherein the substance adhered to the image bearing belt is a toner having a shape factor SF-1 of from 100 to 150.
